(19) United States
(12) Patent Application Publication
(10) Pub. No.: US 2024/0135908 A1
(43) Pub. Date: Apr. 25, 2024

(54) SYSTEM AND METHOD FOR ENHANCED AUDIO DATA TRANSMISSION AND DIGITAL AUDIO MASHUP AUTOMATION

(71) Applicant: Tuttii Inc., Middletown, DE (US)

(72) Inventors: Troy Alexander Skinner, Carpinteria, CA (US); William Jagedal Moran, Menlo Park, CA (US)

(21) Appl. No.: 18/491,271

(22) Filed: Oct. 19, 2023

Related U.S. Application Data
(60) Provisional application No. 63/417,774, filed on Oct. 20, 2022.

(51) Int. Cl. G10H 1/00

(52) U.S. Cl. CPC G10H 1/0025

(57) ABSTRACT

A method for automating audio mashup production is disclosed. First, two or more audio files are received. Based on two or more audio files, two or more stem audio files and reference metadata associated with the two or more audio files are retrieved from a server. Each of the two or more stem audio files includes at least one of an instrument portion or a vocal portion that are included in the two or more audio files. After retrieval of the two or more stem audio files and the reference metadata, at least some musical parameters associated with segments of the two or more stem audio files are adjusted. Thereafter, the two or more stem audio files or adjusted segments of the two or more stem audio files can be combined into a single audio file. The single audio file is output to a user device.

### CROSS REFERENCE TO RELATED APPLICATION

This application claims priority to and the benefit of U.S. Provisional Patent Application Ser. No. 63/417,774 filed on Oct. 20, 2022, the entire disclosure of which is herein incorporated by reference.

### TECHNICAL FIELD

The present disclosure relates generally to enhancing and automating digital audio production, and more specifically, to automating audio editing and producing audio mashup and/or audio remix.

### SUMMARY

A first aspect is a method for audio mashup production. The method includes receiving, by a music production device, two or more audio files; retrieving, based on the two or more audio files and by the music production device, two or more stem audio files and reference metadata associated with the two or more audio files from a data store; adjusting, based on the reference metadata and by the music production device, two or more audio segments of the two or more stem audio files; combining, by the music production device, adjusted two or more audio segments into a single audio file; and outputting, by the music production device, the single audio file. Each of the two or more stem audio files can include at least one of an instrument portion or a vocal portion that are included in the two or more audio files.

A second aspect is a system for producing an audio mashup. The system includes a processor and memory. The memory stores instructions that, when executed by the processor, cause the processor to execute instructions to: receive, by a music production device, two or more audio files; retrieve, based on the two or more audio files and by the music production device, two or more stem audio files and reference metadata associated with the two or more audio files from a data store; adjust, based on the reference metadata and by the music production device, two or more audio segments of the two or more stem audio files; combine, by the music production device, adjusted two or more audio segments into a single audio file; and output, by the music production device, the single audio file. Each of the two or more stem audio files can include at least one of an instrument portion or a vocal portion that are included in the two or more audio files.

A third aspect is a non-transitory computer readable medium storing instructions operable to cause one or more processors to perform operations for automating audio mashup production. The operations include receiving, by a server, two or more audio files; generating, by the server, two or more stem audio files based on the two or more audio files; generating, by the server, reference metadata based on the two or more stem audio files, or the two or more audio files; receiving, by a music production device, the two or more audio files; retrieving, based on the two or more audio files and by the music production device, the two or more stem audio files and the reference metadata from the server; adjusting, based on the reference metadata and by the music production device, two or more audio segments of the two or more stem audio files; and combining, by the music production device, adjusted two or more audio segments into a single audio file.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example an audio mashup automation system for automating production of an audio mashup in accordance with implementations of this disclosure.

FIG. 2 depicts an illustrative processor-based, computing device.

FIG. 3 is an example illustration of the audio editor user interface that is utilized as part of, or in conjunction with an audio mashup automation software for generation of an audio mashup or an audio remix.

FIG. 4 is an example illustration of an audio file presented on a generic beat grid, with a section demarcated in a waveform.

FIG. 5 is an example illustration of the circular nature of musical keys.

FIG. 6 is an example illustration of a spreadsheet that depicts computation or calculation of reference tempo and tempo adjustments to added sections in channels of an audio editor.

FIG. 7 is a flowchart of an example of a technique for automatically generating or producing an audio mashup.

FIG. 8 is a flowchart of an example of a technique for applying channel-specific audio effects to retrieved audios prior to combining channels and applying audio effects to a combined channel to generate or produce an audio mashup.

FIG. 9 is a flowchart of an example of a technique for extracting or creating stem audios and metadata, and using such extracted stem audios and metadata to generate or produce an audio mashup.

### DETAILED DESCRIPTION

Music production encompasses a process of creating a song, from songwriting and arrangement to recording, mixing, and mastering. Within this spectrum, remixing involves reinterpreting an audio track by altering its components to create a different auditory experience. Similarly, creating a mashup involves combining elements (e.g., audio features, sections, stem audios) from two or more distinct audio tracks to produce a cohesive new song. Both of these activities require skills in music production, such as understanding song structure, sound design, and mixing techniques.

Current music production software or technology, such as Digital Audio Workstations (DAWs) and Virtual Studio Technology (VST) plug-ins are notoriously difficult to learn and use effectively. At the same time, music production education is not common or easily accessible for most people including students. The well-known DAWs include the likes of Logic Pro, Ableton®, Pro Tools Studio™, etc., and they are well suited for professionals and extremely dedicated amateurs. Some other services have come out more recently with an emphasis on accessibility, such as Soundtrap® and BandLab, though they still require technical knowledge in both music theory and operating music production software. As such, it is currently not tenable for most people to be casual music producers or digital music-makers, in the way that platforms like Instagram and TikTok enable people to become casual photographers or video makers.

Implementations of the present disclosure address problems such as these by automating certain aspects of music production, such that anybody can make their own musical creations. A user device (through an audio mashup automation software) can have access to a unique library (e.g., a server) of audio data that includes stem audios and reference metadata (e.g., metadata tag identifying numerous characteristics) associated with the audio tracks. For example, the reference metadata may include metadata associated with the audio tracks, the stem audios, production of the audio mashup or audio remix, and information or data that are not included in metadata tag of the audio tracks. In some implementations, a computing device (e.g., the user device, a third-party device) or the server may incorporate a machine-learning model trained to generate the stem audios and/or the reference metadata based on training data (which may include the audio tracks, metadata tag included in or associated with the audio tracks). For example, the training data and output data (e.g., stem audios and/or reference metadata that can be generated based on retrieval or extraction technologies, or are inputted manually) may be logged (e.g., stored or transmitted for storage) in the computing device or the server to train the machine-learning model. Such generated stem audios and/or the reference metadata may also be stored in the library and/or the computing device.

As the user device inputs two or more audio tracks in the software's dedicated audio channels, the user device may automatically retrieve the corresponding stem audios and reference metadata. For example, the user device may concatenate some of metadata tag associated with input audio tracks and location of the dedicated audio channels (e.g., designation information of respective channels, channel data) to generate a unique identifier, which can be used as a lookup to find a matching identifier that links (e.g., under same profile) the respective stem audios and respective reference metadata from the library. Once the respective stem audios and the respective reference metadata are automatically retrieved, the user device may arrange such respective stem audios in the dedicated audio channels, generate reference settings representing musical parameters based on the reference metadata, and apply the reference settings to respective stem audios in the dedicated audio channels. For example, the reference settings may include at least a reference key, a reference tempo, a reference time signature, a master volume, and crossfades. Moreover, the software may modify other audio features, and/or add musical effects to generate and output the audio mashup. To put it another way, the software may use the reference metadata to automatically adjust musical parameters of the stem audios or sections thereof, modify audio features, and/or add musical effects to generate and output the audio mashup. As such, the software may automate, generate, or trigger a cascade of events (e.g., generation of stem audios and the reference metadata, retrieval of the stem audios and the reference metadata, generation and application of the reference settings, application of musical effects, etc.) which ensure that all pieces of are stitched together and layered in a way that ends up sounding harmonious, synchronous, and balanced.

By doing so (e.g., automatically generating such cascade of events based at least on the reference metadata and the stem audios or sections thereof), the user can make his or her own musical creations without acquiring specific knowledge of keys, tempo, rhythm, time stretching, pitch scaling, crossfades, or other music theory or production-related topics.

Reference will now be made in detail to certain illustrative implementations, examples of which are illustrated in the accompanying drawings. Wherever possible, the same reference numbers will be used throughout the drawings to refer to the same or like items.

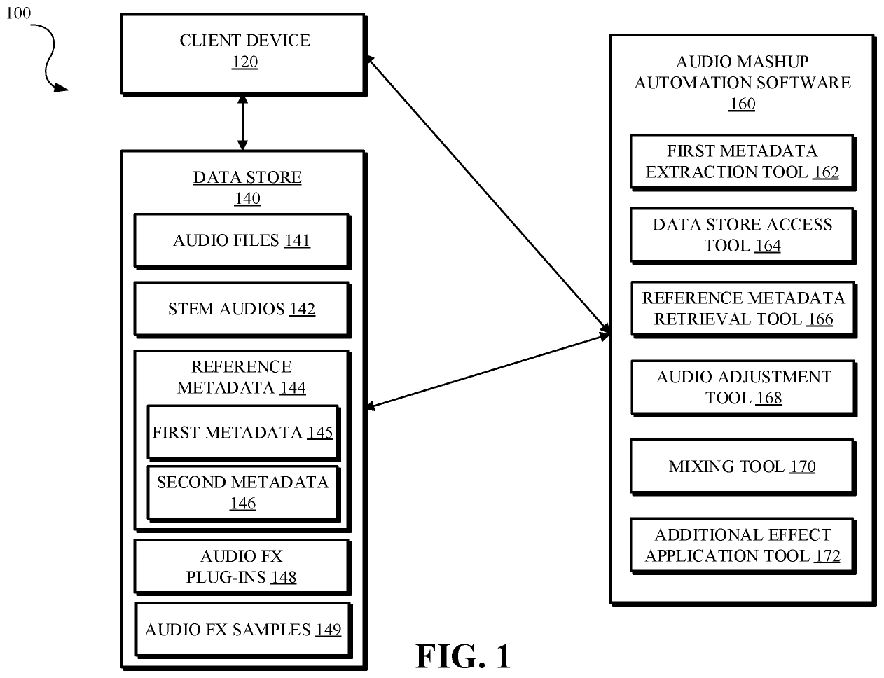

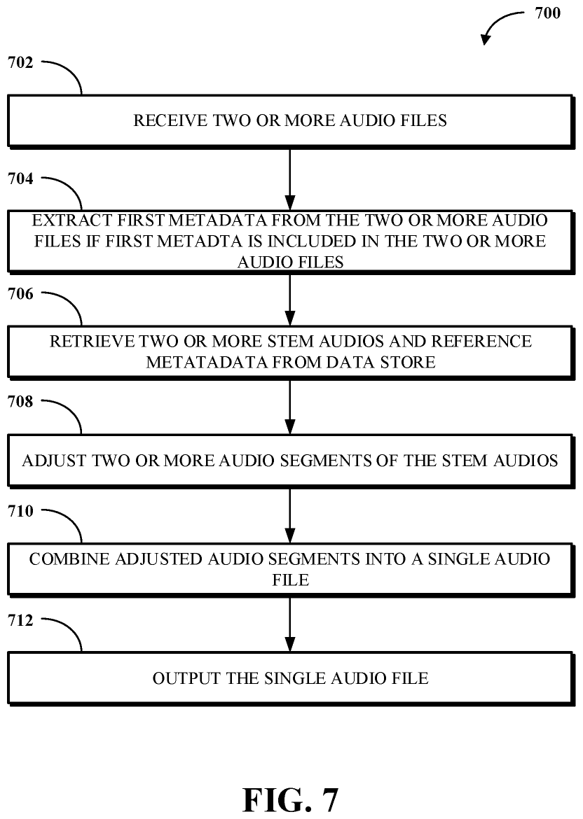

FIG. 1 is a block diagram of an example of a system 100 for automating a production of an audio mashup in accordance with implementations of this disclosure. The system 100 may include a client device 120, a data store 140, and an audio mashup automation software 160. In some implementations, the system 100 may execute method and techniques described in FIGS. 7-9.

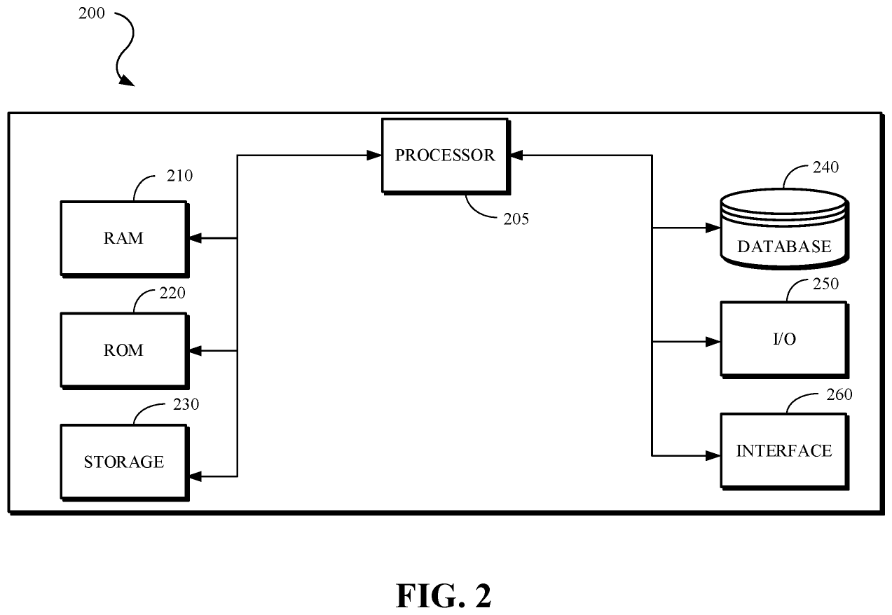

The client device 120 may be a computing device (such as a computing device 200 shown in FIG. 2) including an end-user device, information appliances, mobile computers, laptops, handheld computers, personal media devices, smartphones, notebooks, notepads, and tablets, cloud-based platform, distributed computing platform, and the like. The client device 120 may include or run a software or an application (e.g., the audio mashup automation software 160) for automating the audio mashup in accordance with implementations of this disclosure. Clients or users (e.g., music professionals or amateurs or novices, individuals, end-users, etc.) may be users of the client device 120.

The client device 120 may be connected to or in communication with (collectively “connected to”) a data store 140 via a network. The connections between the client device 120 and the data store 140 may be established as part of implementing the audio mashup automation techniques described herein. The system 100 and the components thereof may include other elements which may be desirable or necessary to implement the devices, systems, compositions, and methods described herein. The network may be and/or may include the internet, an intranet, a local area network (LAN), a wide area network (WAN), a public network, a private network, network gateway, a cellular network, a Wi-Fi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, an IP network, cable, satellite, hybrid coaxial systems, fiberoptic systems, 5G, and like including any combinations thereof. In some implementations, the network may contain one or more servers, network elements or devices, and the like.

The data store 140 may be database(s), server(s), or any combination thereof. The data store 140 may store data associated with implementing the audio mashup automation. The data store 140 may store data that can be retrieved by the client device 120 when the client device 120 is used in conjunction with the audio mashup automation software 160. For example, while or when the client device 120 runs the audio mashup automation software 160, the software may contain built-in logic or instructions to connect to the server, and the connection may be facilitated through network protocols between the client device 120 and the server exchanging data packets.

For example, the data store 140 may be a dedicated server, a virtual private server (VPS), a content delivery network (CDN), a cloud storage solution, a cloud server, a database server, etc. For example, the dedicated server may offer uninterrupted access and high-speed processing, which may be beneficial for applications managing an extensive library of files without shared resource interference. For example, the VPS may provide scalable storage and processing capabilities on a budget. For example, the CDN may ensure fast delivery of audio files (e.g., audio files 141) across the globe by caching content in multiple geographical locations. As such, the CDN may minimize buffering or download delays. Moreover, for example, the CDNs can distribute content to multiple server locations worldwide and users may access data from the nearest server, which may ensure low latency and fast load. For example, the cloud storage solution may handle vast amounts of data and offer high redundancy (e.g., can store multiple copies of data to ensure data availability and protect against data loss). For example, the database server may be efficient in storing and managing structured data.

The data store 140 may include audio files 141, stem audios 142 (e.g., stem audio files, stem audio tracks, stem audio data), reference metadata 144, audio effects (FX) plug-ins 148, and audio FX samples 149. The term “stem” may be a standard industry term. For example, the stem audios 142 may include components of the audio files 141 (e.g., audio data, audio tracks, song, etc.). For example, each stem audio of the stem audios 142 may be a vocal stem or an instrument stem of a respective audio file. For example, consider a “A Day in the Life” song by The Beatles. In “A Day in the Life” song, there are many stem audios, which include vocal portion (of member of the band), acoustic guitar portion, piano portion, bass portion, orchestra portion (consisting of multiple instruments in this scenario), and drum portion. As such, within a single song or audio file, there may be multiple stem audios, and the stem audios may include a single vocal stem audio, a multiple vocals stem audio (where more than one vocal can be a stem audio), an instrument stem audio, and multiple instruments stem audio (where more than one instrument can be a stem audio, such as an instrumental song that is music normally without any vocals). Moreover, even with a single instrument (e.g., a drum), there may be different stem audios (e.g., kick drum, snare drum, toms, etc.). For example, sub-components of a stem audio may themselves be considered stems, such as isolating the snare drum or kick drum from the drummer's audio feed.

Each stem audio may have the same duration (e.g., length, time duration measured in beats, time duration measured in bars) as source audio file. In some implementations, when the stem audio does not have the same duration as the source audio file (e.g., audio file), adjustment can be made such that the stem audio has the same duration as the source audio file. Doing so may enhance processing efficiency. For example, if duration or timestamps of the stem audio do not line up (e.g., out of sync) with the source audio file (e.g., associated audio file), there may be processing issues in accurately locating and synchronizing segments or sections of the stem audio or the source audio file. Moreover, as some metadata that is associated with the stem audios 142 may be sometimes based on timestamps of the audio files 141 (such as when the metadata associated with the stem audios 142 are generated from the audio files 141 instead of the stem audios 142), potential sync issues can be mitigated by ensuring that the stem audios 142 have the same duration or timestamps as the audio files 141.

Accordingly, the stem audios 142 may include a vast number of respective stem audios of, or extracted from, a plethora of audio files (e.g., the audio files 141). In some implementations, the audio files 141 may be collected or obtained by one or more audio providers (e.g., music record label, music distributor, local device storage, digital audio workstation software, or any other sources that have at least some of the audio files 141). Moreover, such collected audio files 141 may be extracted or split into the stem audios 142. For example, such collected audio files 141 may be extracted or split into many different types of the stem audios 142, as described above. Moreover, in some implementations, extraction or retrieval technologies such as self-similarity matrix, neural networks, etc. or other feasible music extraction, retrieval technologies, and/or machine-learning model may be used to automatically extract or split to the stem audios 142 from the audio files 141 as described throughout this disclosure.

The data store 140 may include reference metadata 144. The reference metadata 144 may include first metadata 145 and second metadata 146.

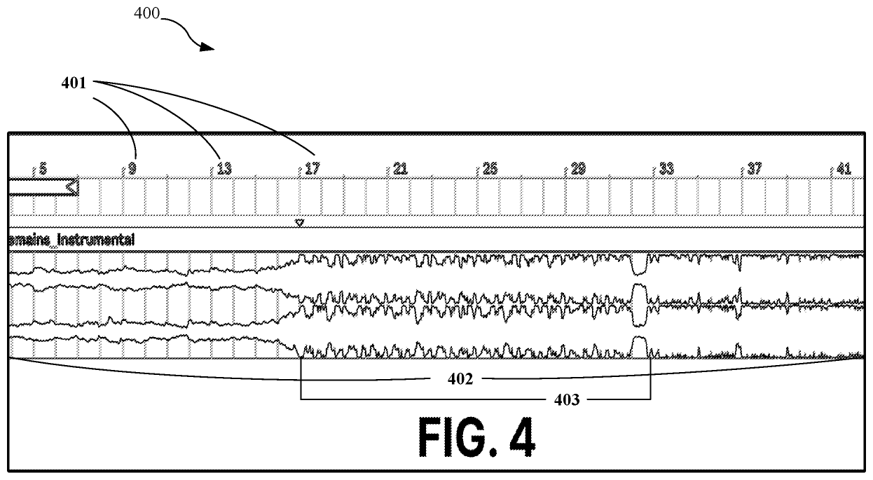

The first metadata 145 may be common metadata (e.g., metadata that is commercial in nature) that can be potentially or sometimes provided with, included in, or embedded in the audio files 141, the stem audios 142, or the audio FX samples 149. For example, the first metadata 145 may be sometimes provided or not provided in the audio files 141, the stem audios 142, or the audio FX samples 149. For example, the first metadata 145 may include information associated with title, artist name, album (which certain audio file(s)) belong to), track number, year, genre, composer, lyricist, or general information associated with the audio files 141, the stem audios 142, and/or the audio FX samples 149. For example, the first metadata 145 may include information associated with tempo, time signature, key, downbeat locations (e.g., first downbeat location), section start timestamps, section categories, and/or energy levels near section starts and ends (e.g., both in total as well as within specific frequency bands) associated with the audio files 141, the stem audios 142, and/or the audio FX samples 149. The term “section” in this disclosure may refer to a distinct portion or a segment of an audio file (of the audio files 141), a stem audio (of the stem audios 142), or an audio FX sample (of the audio FX samples 149). For example, section(s) identified from a song may include verses, choruses, bridges, etc. For example, section(s) identified from the stem audio may be a distinct portion or a segment of the stem audio. For example, FIG. 4 depicts an example of a section 403 from a stem 402, represented as a waveform laid against a beat grid (as indicated by bar markers 401).

Moreover, for example, some of the audio files 141, the stem audios 142, or the audio FX samples 149 may sometimes have one or more of the first metadata 145 included in themselves. On the other hand, the first metadata 145 may not be included in the audio files 141, the stem audios 142, or the audio FX samples 149 at all.

In some implementations, the first metadata 145 may be directly extracted from one or more of the audio files 141 by the client device 120 when the client device retrieves the one or more of the audio files 141 using the audio mashup automation software 160. In some implementations, the first metadata 145 may be retrieved along with respective audio files of the audio files 141 by the client device 120 when the client device retrieves the one or more of the audio files 141 and/or the stem audios 142 using the audio mashup automation software 160. In some implementations, one or more of the first metadata 145 may be directly extracted, accessed, or received by the client device 120 without accessing the data store 140 when the client device 120 receives or accesses one or more audio files and when the one or more audio files include or embed such first metadata 145. Moreover, in some implementations, the first metadata 145 of the stem audios 142 can be derived from the first metadata 145 of the audio files 141.

The second metadata 146 may be metadata that are not common or commercial in nature, and not provided with, included in, or embedded as metadata tag in the audio files 141, the stem audios 142, and/or the audio FX samples 149. The second metadata 146 may be data that can be derived based on certain categories of information (e.g., information associated with producing or creating audio mashup or audio remixes that are not in included in the first metadata 145, information associated with generating and/or applying reference musical parameters) of the audio files 141 and/or of the stem audios 142).

For example, the second metadata 146 may include unique identifier, chronological order, sub-chronological order, a duration (e.g., section duration), an end beat location (e.g., section end beat location), a stem type, a section category, and a sequence associated with the audio files 141 or the stem audios 142.

For example, the chronological order may correspond to a numerical representation of which instance of a particular section type a given section is, as compared to the other instances of that section type in a respective audio file, a respective stem audio, other respective audio segments, or sections thereof (e.g., “verse 1” vs “verse 2”—the chronological order values would be “1” and “2” respectively). Moreover, for example, the chronological order may also refer to and include meanings of a standard term used or well-known in a music production industry.

For example, the sub-chronological order may correspond to a value that indicates the order in which sub-sections (of the sections that are particularly long) occur in a respective audio file, a respective stem audio, other respective audio segments, or sections thereof. For example, consider a 16 bar long verse that is broken in half into “verse 1a” and “verse 1b.” In such scenario, the sub-chronological order values would be “a” and “b” respectively, which together can comprise the entirety of verse 1. For example, with regards to dividing sections into sub-sections, a maximum length of 8 bars for any section can be set as threshold, such that if a section is longer than such threshold, such section can be automatically divided into sub-sections. Moreover, for example, the sub-chronological order may also refer to and include meanings of a standard term used or well-known in a music production industry.

For example, the sequence may correspond to a numerical value assigned to each section to indicate its location relative to all other sections in the original work (e.g. for a song that goes “intro-verse-chorus-outro”, the “outro” has a sequence value of 4, and the “verse” has a sequence value of 2). Moreover, for example, the sequence may also refer to and include meanings of a standard term used or well-known in the music production industry.

For example, the section category may be a descriptor and/or a label used to identify the part of a respective audio file, a respective stem audio, other respective audio segments, or sections thereof, that the section represents within the original structure of the original composition. In common music vernacular, this would be called a “song section” or “part of a song.” For example, imagine a song consisting of the following structure: intro-verse-chorus-verse-chorus-outro. The section categories used in this song would be “intro”, “verse”, “chorus”, and “outro”. As such, the section category may be a means of differentiating the various sections into meaningful groups, and each section category has certain musical implications and/or characteristics that various users would likely recognize (e.g. the user would know that the “chorus” section of a popular song is the part that repeats and is often the most recognizable). Moreover, for example, the section category may also refer to and include meanings of a standard term used or well-known in the music production industry.

For example, the stem type may be an identifier used to indicate what type of stem a given section came from. Some examples of this may be “vocal”, “instrumental”, etc. This may allow the system to ensure that only sections from like stem types are added to the same channel (e.g. only sections with Stem Type=“vocal” can be added to the vocal channel). For example, the stem type may also correspond to stem information described in this disclosure. Moreover, for example, the stem type may also refer to and include meanings of a standard term used or well-known in the music production industry.

For example, the duration may be a length of a given audio segment (e.g., segment or section of a respective audio file, a respective stem audio, other respective audio segments) which can be measured in bars or via common time measurements (e.g., seconds), and converted between the two. Moreover, for example, the duration may also refer to and include meanings of a standard term used or well-known in the music production industry.

For example, the unique identifier may be a respective identifier that can be used to track and/or retrieve respective first metadata, respective second metadata, respective audio file, and/or respective stem audio from the data store 140 by the client device 120 through use of the audio mashup automation software 160.

For example, the unique identifier may correspond to a concatenation of a respective first metadata and/or basic information (e.g., respective title, a respective artist name, or information that may help identify an audio file) associated with a respective audio file. For example, the unique identifier may correspond to a concatenation of a respective title, a respective artist name, and a respective stem information.

In some implementations, when the client device 120 retrieves an audio file of the audio files 141 from the data store 140, the client device 120 may first extract the basic information or receive the basic information associated with the audio file (which may be first metadata or metadata tag included in or that comes with the audio file) to create a respective concatenation of at least some of basic information. Thereafter, the respective concatenation may be used as the unique identifier and/or a lookup (e.g., lookup index) to find a matching unique identifier in the data store 140 to retrieve and/or access respective second metadata (of the second metadata 146), respective first metadata (of the first metadata 145), respective audio file (of the audio files 141), and/or respective stem audio (of the stem audios 142).

In some implementations, when the client device 120 has a stored or downloaded audio file in a memory of the client device 120 or the client device 120 receives, accesses, or retrieves respective audio file in a different database or data store than the data store 140, and the user inputs such audio file into a user interface of the audio mashup automation software 160, then the client device 120 may first extract the basic information or receive the basic information associated with the audio file (which may be one or more of respective first metadata or a metadata tag included in or that comes with the audio file) to create a respective concatenation of at least some of basic information. Thereafter, the respective concatenation may be used as the unique identifier and/or the lookup to find a matching unique identifier in the data store 140 to retrieve or access respective first metadata, respective second metadata, respective audio file, or respective stem audio.

In some implementations, if one or more of the first metadata 145 necessary for producing the audio mashup are not included or embedded in one or more of the audio files 141, such first metadata 145 may be derived from the audio files 141 or the stem audios 142, and/or stored in the data store 140. For example, such information may be derived (e.g., in real-time or not in real-time) using extraction or retrieval technologies such as self-similarity matrix, neural networks, etc. or other feasible music extraction, retrieval technologies, and/or machine-learning model as described below.

In some implementations, the second metadata 146 may be derived from the first metadata 145, provider's (e.g., the one or more audio providers that provide at least some of the audio files 141) metadata, and/or the audio files 141 or the stem audios 142. For example, the second metadata 146 may be generated by using the extraction or retrieval technologies such as self-similarity matrix, neural networks, etc. or other feasible music extraction or retrieval technologies that can extract a certain categories of information (such as one or more metadata of the reference metadata 144) based on the first metadata 145, one or more of the audio files 141, or one or more of the stem audios 142. Moreover, such extraction or retrieval technologies may be used not only to extract or retrieve the certain categories of information such as the first metadata 145 and/or the second metadata 146, but also to relate or associate the extracted second metadata 146 and/or the first metadata 145 to respective stem audios (e.g., the stem audios 142).

In some implementations, a machine-learning (ML) model (which may be a deep-learning (DL) model) may be trained and used to output the first metadata 145 and the second metadata 146 based on audio files 141 and/or the stem audios 142, and/or associate such first metadata 145 and second metadata 146 to the audio files 141 and/or the stem audios 142.

For example, a computing device such as the client device 120 or a third-party computing device, or a server (e.g., the data store 140) may be used to incorporate and/or train the ML model. For example, training data including the first metadata 145, the provider's metadata, the audio files 141, and/or the stem audios 142 may be used. For example, an application or software that incorporates the extraction or retrieval technologies such as self-similarity matrix, and/or neural networks may be used to generate or obtain the first metadata 145 and/or the second metadata 146 based on the training data. Thereafter, the training data and obtained first metadata and/or obtained second metadata may be logged (e.g., stored or transmitted for storage) in the computing device or the server. Thereafter, the ML model may be trained using logged training data and logged first metadata and/or logged second metadata. In some implementations, in supplant of using the application or the software that incorporates the extraction or retrieval technologies to generate the first metadata 145 and the second metadata 146, the first metadata 145 and the second metadata 146 may be derived and entered into the computing device or the server manually, logged in the computing device or the server, and used along with the training data to train the ML model.

In some implementations, the ML model may be trained and used to output not only the first metadata 145 and the second metadata 146, but also the stem audios 142 simultaneously. For example, based on training data including the first metadata 145, the provider's metadata, and/or the audio files 141, the application or software that application or software that incorporates the extraction or retrieval technologies such as self-similarity matrix, and/or neural networks may be used to generate or obtain the stem audios 142 and the second metadata 146. Moreover, the first metadata 145 including respective first metadata of the stem audios 142 may be generated based on the training data. Thereafter, the training data, obtained first metadata, obtained second metadata, and/or obtained stem audios may be logged (e.g., stored or transmitted for storage) in the computing device or a server (e.g., the data store 140). Thereafter, the ML model may be trained using logged training data, logged first metadata, logged second metadata, and/or logged stem audios. In some implementations, one or more deep learning models or one or more ML models may be selectively trained. For example, one of the ML models may be used to train and output the stem audios 142, while the other ML model may be used to train and output the first metadata 145 and/or the second metadata 146. In some implementations, in supplant of using the application or the software that incorporates the extraction or retrieval technology may generate or obtain the stem audios 142, the first metadata 145, and/or the second metadata 146, such data may be derived and entered into the computing device or the server manually, logged in the computing device or the server, and used along with the training data to train the ML model.

In some implementations, the ML model may be trained to associate the first metadata 145 and/or the second metadata 146 to the audio files 141 and/or the stem audios 142.

In some implementations, the first metadata 145 and/or the second metadata 146 may be entered into the data store 140 manually by a human.

Such process of extraction, generation, or derivation (collectively “production”) of the first metadata 145 and/or the second metadata 146 (or more generally, the reference metadata 144) may run in parallel or asynchronously with production of the stem audios 142 based on the audio files 141. For example, the first metadata and/or the second metadata 146 of the stem audios 142 or the audio files 141 may be extracted, generated, or derived (collectively “produced”) while collected audio files 141 are being extracted or split into the stem audios 142 as described above.

In some implementations, with regards to retrieval of the first metadata 145 or the second metadata 146 of the reference metadata 144, one or more of the first metadata 145 or the second metadata 146 may be retrieved based on a content or a purpose of the audio files 141. For example, time signature (as metadata) may not be applicable to, for example, a sample of audio taken from a conversation in a TV show.

In some implementations, the first metadata 145 or the second metadata 146 may be configured and/or stored in a table where each row represents a specific section of audio (each audio file differentiated from the rest of the audio file through their unique identifiers), and each column represents a metadata field for the first metadata 145 or the second metadata 146.

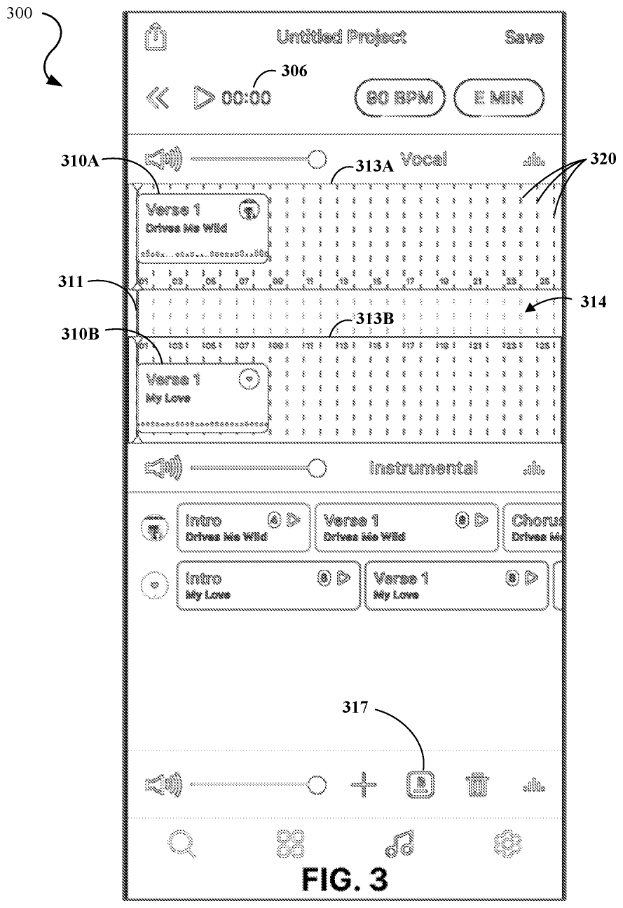

The data store 140 may include the audio FX plug-ins 148 and audio FX samples 149. The audio FX plug-ins 148 may be software components that can be used in or by a software, such as the audio mashup automation software 160, to process and modify audios (such as the audio files 141, the stem audios 142, sections of the audio files 141 and/or the stem audios, audio mashups, audio remixes, etc.). For example, the audio FX plug-ins 148 may be used to modify input audio to generate output audio. For example, the audio FX plug-ins 148, may be conventional plug-ins that are available as open source software. For example, the audio FX plug-ins 148 may take in audio from one or more of the channels in a project (referred to as “bussing” in traditional Digital Audio Workstations (DAWs)), affect that incoming audio in some manner, then output the affected audio (or some blend of the affected audio and the original audio source). For example, the audio FX plug-ins 148 may include reverb, phasers, filter sweeps, etc. Moreover, for example, the audio FX plug-ins 148 may take the form of audio section(s). For example, the audio FX plug-ins 148 and the audio FX samples 149 may have their own dedicated channel that is separate from the stems, which is depicted as an audio FX channel 314 in FIG. 3.

The audio FX samples 149 may be audio files that capture specific effect(s). The audio FX samples 149 may take the form of section(s). Moreover, unlike the audio FX plug-ins 148 which process and modify the input audios, the audio FX samples 149 may themselves be the audio files (in similar manner as the stem audios 142 or the sections of the stem audios 142, as opposed to the audio FX plug-ins 148). For example, the audio FX samples may include noise risers, pitch risers, downlifters, crash cymbals, etc.

The audio FX plug-ins 148 and the audio FX samples 149 can be collectively referred to as “audio FX sections” in this disclosure.

In some implementations, some audio FX sections may incorporate elements of both sample-based and processing-based audio FX to generate output audio (e.g., using sampler plug-ins to generate noise risers).

In some implementations, the unique identifiers may be used to track (or look up) and retrieve respective audio FX plug-ins and/or respective audio FX samples from the data store 140. For example, the unique identifiers may link not only respective first metadata, respective second metadata, respective audio file, and respective stem audio, but also respective audio FX plug-ins and/or respective audio FX samples. For example, respective first metadata, respective second metadata, respective audio FX plug-ins and/or respective audio FX samples associated with respective audio file and respective stem audios may be stored under the same profile or the unique identifier in the data store 140.

In some implementations, the audio files 141, the stem audios 142, the reference metadata 144, the audio FX plug-ins 148, the audio FX samples 149 do not necessarily have to be stored in the same data store 140, but each of or combination of the audio files 141, the stem audios 142, the reference metadata 144, the audio FX plug-ins 148, the audio FX samples 149 can be stored in different types of data stores, stored in the memory of client device, or other suitable medium to enhance efficiency and security, and/or reduce latency.

In some implementations, the audio files 141, the stem audios 142, the reference metadata 144, the audio FX plug-ins 148, and/or the audio FX samples 149 may be downloaded to the client device 120.

The data in the data store 140, which includes the audio files 141, the stem audios 142, the reference metadata 144, the audio FX plug-ins 148, and the audio FX samples 149 may be used, accessed, or processed by the client device 120 through the audio mashup automation software 160.

The audio mashup automation software 160 may be used by a computing device, such as the client device 120, to generate audio mashup, audio remix, or other output audio file based on input audios (e.g., the audio files 141, the stem audios 142, sections of the audio files 141 and/or the stem audios, the audio FX sections, any combination thereof, etc.).

The audio mashup automation software 160 may include tools, such as programs, subprograms, functions, routines, subroutines, operations, executable instructions, and/or the like for, inter alia and as further described below, generate the audio mashup, audio remix, or other output audio file based on the input audios.

At least some of audio mashup automation software 160 can be implemented as respective software programs that may be executed by the client device 120. A software program can include machine-readable instructions that may be stored in a memory (such as the memory of the client device 120), and that, when executed by the processor, cause the client device 120 to perform the instructions of the software program. As shown, the audio mashup automation software 160 may include at least a first metadata extraction tool 162, a data store access tool 164, a reference metadata retrieval tool 166, an audio adjustment tool 168, a mixing tool 170, and an additional effect application tool 172. In some implementations, audio mashup automation software 160 can include more or fewer tools. In some implementations, some of the tools may be combined, some of the tools may be split into more tools, or a combination thereof. In some implementations, audio mashup automation software 160 may run on the server (e.g., data store or other server), or both the client device 120 and the server.

As described above, the audio mashup automation software 160 may be used to generate the audio mashup, audio remix, or other output audio file based on the input audios.

The audio mashup automation software 160 may receive or be used to receive two or more of input audios (e.g., such as two or more of the audio files 141, section(s) of the audio files 141, the audio FX sections, any combination thereof which is feasible to generate audio mashup or remix, etc.). For example, a user of the client device 120 may enter, select, or input two or more of the input audios through the audio mashup automation software 160. For example, the user may browse through, search for, or access the list of the audio files 141 of the data store 140 through a data store access tool 164, and select two or more input audios of user's choice. For example, the user may select a song 1 and a song 2. For example, the user may select a section of the song 1 and a section of the song 2. For example, the user may select the song 1, a song 4, and song 5. Any combination of two or more input audios may be entered or inputted.

For example, the two or more input audios can be entered or inputted to audio editor user interface 300 as illustrated in FIG. 3. In FIG. 3, a section 310A of song A (“Drives Me Wild”) and a section 310B of song B (“My Love”) are entered. More specifically, the section 310A is entered in a vocal channel 313A and the section 310B is entered in an instrumental channel 313B. The vocal channel 313A may be a channel that designated or is used for retrieving a vocal stem audio of the input audio (e.g., section 310A of song A in this case), and the instrumental channel 313B may be a channel that is designated or used for retrieving an instrumental stem audio of the input audio (e.g., section 310B of song B in this case). Even though only two channels corresponding to the vocal stem audio channel and instrumental stem audio channel are shown as example, there can be many different types of channels. For example, there may be channels configured to retrieve different types of stem audios, such as single instrument, multiple instruments, single vocal, multiple vocals, the audio FX sections, etc. For example, individual channel can be designated to a stem audio type (e.g., stem type) of acoustic guitar, piano, bass, orchestra (consisting of multiple instruments), drum, a single vocal, multiple vocals, drum, sub-components drum (e.g., kick drum, snare drum, toms), etc.

For example, assuming that the user prefers to use the guitar stem audio from the song C, then the user may input or place the input audio into a channel corresponding to guitar stem audio channel. For example, assuming that the user prefers to use the piano stem audio from the song D, then the user may input or place the input audio into a channel corresponding to piano stem audio channel.

As such, by entering or inputting audio input on appropriate channel location (or to certain designated channel), designated type (e.g., of user's preference) of stem audio associated with the input audio may be automatically retrieved from the data store 140.

Moreover, the stem audio to be retrieved may have the same duration as the input audio. In some implementations, when the stem audio does not have the same duration as the source audio file (e.g., audio file), adjustment can be made such that the stem audio has the same duration as the source audio file. For example, when certain section(s) of a respective song, but not the entire song, is inputted into a respective channel, stem audio retrieved may correspond to that certain section(s) of the respective song. To put it another way, if the entire respective song has a corresponding guitar stem, and if only certain section of the entire respective song is inputted, then only section of the guitar stem corresponding to that certain section may be retrieved. The retrieval of stem audio is further described below in details.

In some implementations, the user may input one or more input audios that are located in a different server or stored in the client device 120.

Once the input audio is entered or inputted, the first metadata extraction tool 162 may then be used to receive, identify, and/or extract at least some of respective first metadata (or respective metadata tag) and/or basic information associated with each of the two or more input audios when at least some of the respective first metadata is provided with, included in, or embedded (e.g., as metadata tag) in the two or more input audios. Then the first metadata extraction tool 162 or the additional tool associated with the audio mashup automation software 160 may generate or determine a respective identifier for each of the one or more input audios. The term “unique identifier” and “identifier” may be used interchangeably.

For example, based on a concatenation of the respective first metadata and stem information, the respective identifier may be formed or generated. For example, the respective stem information may correspond to which type of stem audio (e.g., guitar stem, instrumental stem, vocal stem, etc.) associated with the respective audio input should be retrieved from the data store 140. For example, the respective stem information may be derived from location of the audio input, such as designation or location of channel (e.g., the vocal channel 313A, the instrumental channel 313B as shown in FIG. 3), as described above. Since the designation or the location of the audio input may be linked with type of the stem audio to be retrieved, when the audio input is in that very location (e.g., designated channel for certain stem type), the respective stem information may be derived or identified, and further included in the concatenation. By including the respective stem information in the concatenation or using the respective stem information for generating the respective identifier, retrieval of exact type of stem audio (e.g., of user's preference) may be automated without further user interaction (e.g., of user having to select a stem out of many different stem options in case the multiple stem options are retrieved).

Even though only example with the title, the artist's name, and the stem information is provided with regards to concatenation that is used to generate or represent the identifier, more or less of the received, identified, or extracted first metadata may be used to form or generate the concatenation for generating or representing the identifier.

Once the identifier is generated or determined based on extracted first metadata of the each of two or more input audios, the audio mashup automation software 160 may (e.g., through use of the data store access tool 164, the reference metadata retrieval tool 166, and/or additional tool(s)) retrieve respective stem audios (of the stem audios 142) and/or respective reference metadata (of the reference metadata 144) based on the respective identifier from the data store 140.

For example, in some implementations, the respective stem audio and the respective reference metadata of the respective input audios are stored under a profile represented by the respective identifier, or linked by the respective identifier in the data store 140. As such, the data store access tool 164 may first determine respective identifier based on extracted first metadata (as described above) and use such respective identifier as a lookup for the respective stem audio and the respective reference metadata from the data store 140. For example, the data store access tool 164 may compare the respective identifier determined to stored identifier to see if they match, and if matched, the data store access tool 164 may be used to retrieve the respective stem audio and the respective reference metadata associated with the audio from the data store 140.

To illustrate, assume that song A has a vocal portion, an acoustic guitar portion, a piano portion, a bass portion, and a drum portion, and assume that song A is entered (e.g., uploaded, inputted) into a guitar channel. Once the identifier according to input song A is determined, such identifier may be used to retrieve respective stem audio (e.g., in this scenario, stem audio would be guitar stem audio) and respective reference metadata.

Moreover, in a different example, assume that song A has a vocal portion, an acoustic guitar portion, a piano portion, a bass portion, and a drum portion, and assume that song A is put into an instrumental channel (e.g., the instrumental channel 313B). Once the identifier according to input song A is determined, such identifier may be used to retrieve respective stem audio (e.g., in this scenario, stem audio would be instrumental that includes all of acoustic guitar portion, piano portion, bass portion, drum portion) and respective reference metadata.

For example, the reference metadata may be respective second metadata (of the second metadata 146) assuming that the respective first metadata has been extracted based on the input audio (without accessing the reference metadata 144 of the data store 140) prior to generating or determining the identifier. If some of first metadata are not extracted based on the input audio, then necessary first metadata may also be retrieved as the reference metadata from the data store 140 in addition to retrieving the respective second metadata. Moreover, if one or more of first metadata, such as first metadata that are specific to and associated with the stem audios (that are to be retrieved or retrieved) are needed and/or missing from the extracted first metadata, then such first metadata may be retrieved from the data store 140 in addition to retrieving the respective second metadata.

In some implementations, in addition to the retrieval of the respective stem audios and the respective reference metadata, recommended audio FX plug-ins and/or recommended audio FX samples (collectively “recommended audio FX sections”) that are associated with the respective input audio or the respective stem audio may be automatically retrieved. In some implementations, the recommended audio FX sections may be automatically retrieved.

In some implementations, rather than extracting respective first metadata based on the input audio to generate or determine the respective identifier (that is used to search the data store 140), other methods may be used to search the data store 140 and retrieve respective stem audios, respective reference metadata, and/or respective audio FX sections. For example, if the user accesses the list of the audio files 141 of the data store 140 through the data store access tool 164, and the user selects one or more the audio files 141 that are automatically linked to (or associated with) the stem audios 142 as input audio, the respective stem audios, the respective reference metadata, and the respective audio FX sections can be retrieved through a profile or a different identifier (other than the unique identifier based on concatenation of one or more of extracted first metadata through the first metadata extraction tool 162).

As described above, since retrieved stem audios may be dependent on duration of audio that is inputted (e.g., section(s), whether it is an entire audio or portion of input audio), the retrieved stem audios may correspond to a certain section of an entire stem when the input audio is a section of source audio or audio file.

In some implementations, after the retrieval of the respective stem audios, the respective reference metadata, and/or respective audio FX sections, the user may optionally control placement of sections of such retrieved stem audios and/or the audio FX sections. For example, consider a vocal stem of a song E with structure “intro-verse-chorus-outro.” In such scenario, the user may have the option of manipulating such structure in any order. For example, the vocal stem may be manipulated into the following order: “verse-outro-chorus-intro.”

After the retrieval of the respective stem audios, the respective reference metadata, and/or respective audio FX sections, the audio adjustment tool 168 may automatically adjust the respective stem audios and/or the respective audio FX sections based on the respective reference metadata. For example, the audio adjustment tool 168 may utilize and/or apply reference settings (e.g., global project settings) for the respective reference metadata to the respective stem audios and/or the respective audio FX sections. For example, the audio adjustment tool 168 can, based on the respective reference metadata, utilize and/or apply the global project settings to the respective stem audios. The global project settings may be master project settings, reference project settings, or commands that can be generated based on the respective reference metadata (e.g., first metadata or second metadata associated with respective stem audios, respective audio files, and/or respective audio FX sections) and be utilized on or applied to the respective stem audios, the respective audio files, and/or the respective audio FX sections. For example, the global project settings may be generated by using the audio adjustment tool 168 and utilized on or applied to the respective stem audios, the respective audio files, or the respective audio FX sections by the audio adjustment tool 168. For example, applying the global project settings to the respective stem audios, the respective audio files, or the respective audio FX sections may include utilizing, applying, or modifying key, tempo, time signature, master volume, and/or crossfades on the respective stem audios, the respective audio files, or the respective audio FX sections based on global parameters (e.g., master parameters, reference parameters, commands) represented by the global project settings. Moreover, for example, applying the global project settings to the respective stem audios, the respective audio files, or the respective audio FX sections may include adjusting or modifying a sequence or a location (e.g., section location within a channel) where the respective stem audios, the respective audio files, or the respective audio FX sections will be placed.

For example, the global project settings can be automatically generated (through the audio adjustment tool 168 or other tools of the audio mashup automation software 160) based on the respective reference metadata or the respective stem audios, and automatically applied to the respective stem audios, the respective audio files, or the respective audio FX sections. In some implementations, the reference settings or the global project settings can be manually set or adjusted by the user before or after the audio input is inputted or entered.

As such, after the retrieval of the respective stem audios and the respective reference metadata, the audio adjustment tool 168 may automatically adjust one or more of the respective stem audios or one or more of the respective audio FX sections based on the respective reference metadata (which includes respective first metadata and respective second metadata).

Further details regarding the generation of the global project settings and application, adjustments, or modifications (of the key, the tempo, the time signature, the master volume, the crossfades, the sequence, or the location) of the respective stem audios, the respective audio files, or the respective audio FX sections based on the global project settings are described below.

Generation and/or Application of the Global Project Settings: Key

With regards to the generation of the global project settings, determining the reference key (as a global project setting or global parameter that represents the global project setting) may include determining, based on the reference metadata (respective first metadata and/or the respective second metadata), a minimum number of semitones that need to be adjusted in at least one of the two or more retrieved stem audios. Such reference key may be applied or used to modify the key of the respective stem audios, the respective audio files, or the respective audio FX sections.

For example, consider an audio editor that includes two channels, with one vocal channel and one instrumental channel. As described above, the vocal channel (e.g., the vocal channel 313A) may be a channel that is used for retrieving a vocal stem audio of the input audio (e.g., the section 310A), and the instrumental channel (e.g., the instrumental channel 313B) may be a channel that is used for retrieving an instrumental stem audio of the input audio (e.g., the section 310B). For example, consider that the vocal stem audio and the instrumental stem audio are automatically retrieved. The reference key, in this example, may be based only on an audio of the instrumental channel, as it helps or plays a significant role in producing bass and sub frequencies. The amount of manipulation done to the low end frequencies of the instrumental stem audio or portion(s) thereof can be minimized to preserve the bass as much as possible. In some implementations, different weights of manipulations can be assigned to different channels and all channels may also be considered for manipulations.

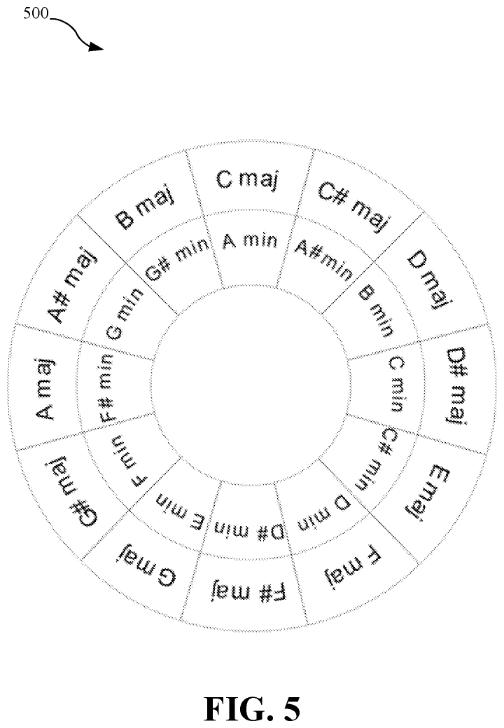

For example, with one vocal channel and one instrumental channel example, to determine the reference key, first, it may be necessary to determine a number of semitones of retrieved stem audio included in the instrumental channel that is needed to be adjusted to reach every major and minor key. For example, for some audios it may make more sense to go down in pitch to reach a given key, and for others it may make more sense to go up in pitch. For example, refer to FIG. 5 for an illustration of this concept. As such, it may be necessary to identify the minimum semitone adjustment required for each audio or each of the retrieved stem audios to be changed to each key. Thereafter, it may be necessary to take an average of these adjustments by key, so that average adjustment required across each audio or each of the retrieved stem audios to reach each key can be known. Such minimum average adjustment can be the reference key. If there are multiple results with the same minimum average adjustment, it may be necessary to identify the maximum adjustment required of each audio or each of the retrieved stem audios to reach each key. Whichever key has the lowest maximum adjustment may be the reference key. If there is still a tie, the audio adjustment tool 168 may arbitrarily choose between the tying keys as the reference key.

Such reference key may be applied or used to modify key of the respective stem audios. For example, when a section is added as audio input to a project and respective stem audio is retrieved, which is already set to a particular key, such respective stem audio may be adjusted to match the reference key. The audio adjustment tool 168 may utilize the relationship between relative major and minor key modes to match keys across those modes. For example, C major and A minor are relative keys, meaning that they share all of the same notes, so the audio adjustment tool 168 can effectively treat them as the same thing. For example, calculation (e.g., computation) as to how many semitones the section would need to be raised by to go up in pitch and match the reference key can be conducted, and the same can be done for going lower in pitch to match the reference key. The section may be adjusted whichever way requires the least amount of manipulation, in an effort to preserve audio quality. As such, the reference key may be based on or generated based on audio inputs or the retrieved audios.

In some implementations, the reference key may be automatically applied to audio inputs or the retrieved audios including the respective stem audio, respective audio files, the respective audio FX sections.

In some implementations, the reference key may be output as a recommendation to the user such that the user may have the option to interact and manipulate the reference key.

Generation and/or Application of the Global Project Settings: Tempo

With regards to the generation of the global project settings, determining the reference tempo (as a global project setting or global parameter that represents the global project setting) may include determining, based on the reference metadata (first metadata and/or the second metadata), an average tempo of retrieved stem audios that are going to be combined to create the audio mashup or audio remix, and computing or identifying the reference tempo based on the average tempo. For example, computing or identifying the reference tempo based on the average tempo may include determining a first difference between a respective tempo of at least one of the retrieved stem audio and the average tempo, determining a second difference between the respective tempo and twice value of the average tempo, determining a third difference between the respective tempo and half value of the average tempo, and determining a smallest value among the first difference, the second difference, and the third difference. Then the reference tempo may be a tempo corresponding to one of the average tempo, the twice value of the average tempo, and the half value of the average tempo, whichever one that led to the smallest value.

Moreover, in some implementations, in supplant of the average tempo, certain project tempo can be manually set by the user, or pre-configured or configured in the audio mashup automation software 160. In such case, such project tempo may be used in computing or identifying the reference tempo. For example, computing or identifying the reference tempo based on the project tempo may include determining a first difference between a respective tempo of at least one of the retrieved stem audio and the project tempo, determining a second difference between the respective tempo and twice value of the project tempo, determining a third difference between the respective tempo and half value of the project tempo, and determining a smallest value among the first difference, the second difference, and the third difference. Then the reference tempo may be a tempo corresponding to one of the project tempo, the twice value of the project tempo, and the half value of the project tempo that led to the smallest value.

In some implementations, the reference tempo can be based on audio(s) in any of the channels of the editor. For example, the average tempo of retrieved stem audios (that are going to be combined to create the audio mashup or audio remix), e.g., measured in Beats Per Minute (BPM), can be determined. For example, in supplant of the average tempo, certain project tempo can be manually set by the user, or pre-configured or configured. These processes would minimize the manipulation required on two or more of retrieved stem audios that are going to be combined to create the audio mashup or audio remix.

For example, consider an editor with an interface containing three channels, one vocal channel, one instrumental channel, and one audio FX channel. Once the project tempo is set or configured, the audio adjustment tool 168 may automatically compare any of sections or retrieved audios of the channels to that average tempo and determine if the section(s) or the retrieved audios should be adjusted to better match. To do this, the audio adjustment tool 168 may determine or compute the absolute value of the difference between the sections or the retrieved audio's BPM and the project tempo, one half of the project tempo, and double the project tempo. Whichever tempo (among the project tempo, one half the project tempo, doubled project tempo) has the smallest difference may be a tempo that the audio adjustment tool 168 may be the reference tempo that corresponding section of the channel or the channel will use to adjust its tempo (e.g., through the audio adjustment tool 168).

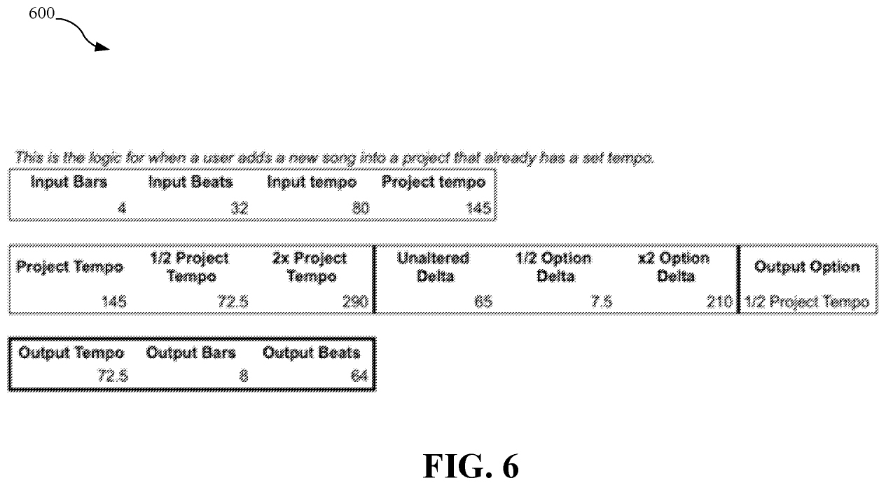

For example, as illustrated in spreadsheet of FIG. 6, consider that 80 BPM section is being added to a 145 BPM project tempo. To adjust to 145 BPM, the section must be sped up by 65 BPM. To adjust to 72.5 BPM (half of the project tempo), the section must be slowed down by 7.5 BPM. To adjust to 290 BPM (doubled project tempo), the section must be sped up by 210 BPM. As such, the section is slowed from 80 BPM to 72.5 BPM upon import to the channel. However, the section was adjusted to 72.5 BPM to fit into a 145 BPM project, meaning that the duration metadata measured in beats and bars must be updated as well. This is because 1 beat at 72.5 BPM is twice as long as 1 beat at 145 BPM. As a rule, when the audio input or the retrieved audio (e.g., retrieved stem audio, retrieved audio FX section) is half the project tempo, the beat and bar duration metadata must be doubled. Inversely, when the audio input or retrieved audio is twice the project BPM, the duration metadata must be halved. Such rules may also apply when the project tempo is supplanted with the average tempo as described above.

Generation and/or Application of the Global Project Settings: Time Signature and Alignment

With regards to the generation of the global project settings, determining the reference time signature (as a global project setting or global parameter that represents the global project setting) may include determining, based on the reference metadata (first metadata and/or the second metadata), alignment locations for the two or more retrieved stem audios. Such reference time signature may allow for synchronous playback when two or more retrieved stem audios are combined. More details are described below.

The time signature may refer to the number of beats per bar and bars per meter as described below. The synchronization and relative alignment of the various sections may be based on the time signature, downbeat location, and/or duration as described below. Moreover, the time signature and the alignment may include meanings of standard industry terms.

Referring to FIG. 3, the concept of a “beat grid” as the background of the channels 313 and 314 is illustrated. These dashed lines (e.g., dashed lines 320) represent “bars,” a musical concept referring to a collection of beats, the number of which varies based on the time signature. For a project set to a 4/4 time signature, one bar is equal to 4 beats. A beat grid may be a useful tool to conceptualize how to synchronize the audio based on the locations of various beats within the sections. The audio adjustment tool 168 can convert locations on the beat grid, typically measured in bars in a user interface and displayed with a playhead (such as a playhead 311), into time. This can be done by determining or computing how long a beat is in seconds, and measuring how many beats from the origin that is to be computed for. For example, 4 bars in a project that is 60 BPM is 16 seconds long (4 bars=16 beats. 60 BPM=60 beats per 60 seconds=1 beat per second, and therefore, 16 beats=16 seconds). This plus the reference metadata provides the information necessary to determine the alignment locations and appropriately time the playback of the various sections (e.g., of the two or more retrieved stem audios). In this way, the locations of beats within the sections themselves is known, or can quickly be calculated, with the reference metadata. The timestamp or location of the start of the first beat of each section within a respective stem audio or respective audio file at its original tempo (referred herein as the “first downbeat location” that is included in or stored as the reference metadata) is known, and if the section's BPM has been adjusted to fit in the project (e.g., adjusted based on the global project settings or the reference tempo), the new timestamp can be determined or computed (using the timestamp and section's BPM information to calculate the location measured in beats, then using that location in beats and the project's BPM to calculate the timestamp at the new tempo). Additionally, a given section's duration is known and stored as reference metadata as well. The duration of the section at its original tempo is typically measured in bars, but can be converted to timestamps via the same transformation described above with respect to the first downbeat locations. The duration information may then be used to indicate how long to play a particular section for at any tempo before transitioning to the next section (or before ending playback, if the section is the final section in a channel). Using the beat grid information, the first downbeat location, and/or the duration, the audio adjustment tool 168 can determine the alignment locations as described above, and align the various channels for synchronous playback accordingly, and can ensure that each individual channel remains onbeat as it transitions sequentially from section to section.

Moreover, for example, when a section or the retrieved audio is added to a channel, the start of the first beat of that section can be aligned with the start of the first beat of the beat grid (illustrated with the sections 310A and 310B in FIG. 3, which are all the way to the left within channels, because they are the first sections in their respective channels). Each additional section that comes after the first section within the channel would be aligned such that the very end of the last beat of the preceding section is aligned with the start of the first beat of the following section. This relationship between the end of the last beat and start of the first beat is always maintained for all neighboring sections within a channel.

Generation and/or Application of the Global Project Settings: Master Volume and Crossfades

With regards to the generation of the global project settings, determining the master volume (e.g., reference volume) as a global project setting or global parameter that represents the global project setting) may include comparing, based on the first metadata or the second metadata, volume of neighboring sections or the retrieved audios of the channels (e.g., the vocal channel 313A, the instrumental channel 313B) to be combined to create the audio mashup or the audio remix.

For example, various audio input (e.g., which may be obtained from different audio providers as described above), may have been mastered at different volume levels when such audio input was inputted or entered into a user interface, such as the audio editor user interface 300. To account for this, the audio adjustment tool 168 may compare the neighboring sections or the retrieved audios of the channels to determine the master volume such that the difference in volume, measured in integrated LUFs, between such sections and the master volume (or difference in volume between the retrieved audios and the master volume) is within a specified dB range. Such volume information of each of the sections or the retrieved audios that are used for determining the master volume is provided in the respective second metadata (of the second metadata 146).

Once the master volume is determined, the audio adjustment tool 168 may apply the master volume to the sections or the retrieved audios that are to be combined to create or generate the audio mashup or the audio remix.

In some implementations, master volume may be manually set based on a user preference, which can override the automatic system adjustments.

Crossfades may be applied (by using the audio adjustment tool 168) between neighboring sections (e.g., multiple sections of a single audio file, multiple sections of a single stem audio such as described above with respect to song E example, etc.) within the same channel as each other. For example, the crossfades may be applied when the neighboring sections of the single stem audio or the single audio file within the same channel are not in original order as they were ordered in the single stem audio or the single audio file. For example, consider the example with the song E (which is described above) where original “intro-verse-chorus-outro” is manipulated by the user into a new order of “verse-outro-chorus-intro.” In scenarios such as this, the crossfades need to be applied. If the crossfades are not applied in such scenarios, unpleasant audio artifact such as “clipping” or “popping” may result.

The location of crossfade crossover point and crossfade duration may have default values, which may be adjusted automatically based on respective reference metadata for each of the neighboring sections. The default value for these parameters may be different depending on how it is pre-configured or configured into the audio mashup automation software 160. In some implementations, the crossover point may be located at the moment that the end beat of one section ends and the first beat of the next section begins. For example, the default crossfade duration may be 10 milliseconds, and the crossover point may be directly in the center of the total crossfade. Respective first metadata or respective second metadata associated with the sections can be used in a few ways (attack preservation, lead-in preservation, and tail preservation) to adjust the default values. The details are described below.

Crossfades—Attack Preservation:

This is an adjustment to the crossover point that can be made to preserve the full attack of the start of a section. In some embodiments, this may be a default value for the crossover point between sections with certain stem types. In this example, attack preservation may be applied to all sections in the instrumental channel (e.g., the instrumental channel 313B) by default, to ensure the full attack of a kick drum on the first beat of each section is preserved. To perform this adjustment, the crossover point is moved from its default position to a new location that is one half of the total crossfade duration earlier. In the example with a 10 millisecond crossfade, the crossover point would be moved to the left on the channel timeline by 5 milliseconds, to ensure that the entire crossfade is complete by the time that the next section begins (thus ensuring the full attack of that section is played at 100% of its volume before making any adjustments on a channel mixer. Channel mixer adjustments, which are performed after the audio adjustment tool 168 applies global settings to the retrieved audios, will be covered in more detail later in the description. Attack preservation may also be triggered by respective reference metadata describing the low frequency band energy levels at the start of a section, which can be used as a proxy to indicate a kick drum or quick attack on a plucky bass instrument. Thus when two sections are neighboring, and the second section has low frequency band energy levels at its start that surpasses a certain predefined threshold, attack preservation can be triggered.

Crossfades—Lead-In Preservation:

This is an adjustment to the crossfade duration and crossover point location based on a given section that has a lead-in, which is a related audio information prior to a section's first beat timestamp. In music, this concept may also be referred to as an “anacrusis,” a “pickup,” or an “upbeat.” The presence of the lead-in may be derived from energy information prior to a section's first beat, or may be identified in its respective reference metadata. While lead-in preservation may be applied to any channel, it is most likely to be used on vocal stems. This adjustment works much like attack preservation, in that it forces the crossover point to occur earlier within the timeline, though with a variable adjustment distance. Moreover, the crossfade duration may also be adjusted to allow for a longer and smoother transition between sections. The respective reference metadata triggering lead-in preservation indicates timestamp at which the lead-in begins (or approximately begins), which may inform how to adjust the crossover point and crossfade duration. For example, the audio adjustment tool 168 may nudge the crossover point by one half of the difference between the timestamp of the lead-in and timestamp of the first beat earlier in the timeline. The audio adjustment tool 158 may then extend the duration of the crossfade to be the difference between the timestamp of the lead-in and timestamp of the first beat. In this way, the crossfade can begin right when the lead-in begins, and grows louder until it represents 100% of the audio coming from its channel right at the first beat timestamp.

Crossfades—Tail Preservation:

This is effectively the inverse of lead-in preservation, meaning that it captures tails of audio sections. A tail is meaningful, related audio information that occurs after the end of a section's last beat. This concept may be less formalized in music vocabulary, but may be described as “over the bar line phrasing.” Generally speaking, tails of one section are of lower importance than the audio of their succeeding sections, but there may be certain circumstances where prioritizing a tail is desirable. Respective reference metadata for tails are similar in nature to those of lead-ins, in that they indicate the timestamp at which the tail ends. For example, consider a vocal section with a tail, followed immediately by no other section, or a section that has no audio information (either a “blank” section, described below, or simply another vocal section that does not contain any audio). In this scenario, one embodiment of the system may move the crossover point to the right on the timeline by the difference between the tail timestamp and the timestamp of the end of the last beat of the section. This allows the full tail to be captured at 100% volume. In some embodiments, adjustments may be computed or calculated slightly differently, for example moving the crossover point by half the difference and making the duration equal to the difference, much like the lead-in adjustment described above.

Crossfades—Audio FX Sections:

Audio FX sections may not be subject to crossfading automation. Instead, the audio generated from an audio FX section, whether sample-based or processing-based, may play out at its full volume for its entire duration regardless of any neighboring sections. For example, consider a reverb audio FX section immediately followed by a pitch riser audio FX section. The reverb tail produced by the first section would play out according to that audio FX section's parameters even while the pitch riser begins playing.

Moreover, the global project settings (except for the crossfades) may be applied to the audio FX sections in a similar manner as applied to the retrieved stem audios (or sections thereof), to the audio FX sections. Moreover, the duration of a given audio FX section may be scaled to fit a predefined bar length within the beat grid based on time signature (a 4 bar reverb audio FX, an 8 bar phaser audio FX, etc.).

With regards to respective audio FX plug-in of the audio FX section, the global project settings for the retrieved stem audios may affect respective global project settings for the audio FX plug-in. With regards to respective audio FX samples of the audio FX section, the global project settings may be the same as the global project settings for the retrieved stem audios (e.g., since audio FX samples are similar to stem sections in that they are also audio files, as opposed to plug-ins). For example, key and tempo of the audio FX samples may be adjusted as they are snapped into the beat grid in predefined increments, which depend on the time signature of the global project settings. Snapping may be an action of forcing alignment of the audio FX samples to certain locations in the beat grid. For example, for a project in 4/4 time, the snapping is typically done in 2 bar increments. For example, in FIG. 3, the audio FX section added to the audio FX channel 314 may start at the dotted lines indicating bar 1, bar 3, bar 5, bar 7, etc. with no need for a preceding blank or audio FX section (which is different from typical stem sections, which are strung together end to end automatically as they are arranged in a channel).

In addition to the generation of the global project settings and application, adjustments, or modifications (of the key, the tempo, the time signature, the master volume, the crossfades, the sequence, or the location) of the respective stem audios, the respective audio files, and/or the respective audio FX sections based on the global project settings, beginning or introduction section (intro) and ending section (outro) of the retrieved audio or audios in the channel may be adjusted.

Intros and Outros

Intros and outros adjustment is similar to lead-in and tail adjustments, but the intros and outros adjustment conveys capturing lead-in and tail audio for particular sections based on that section's location within both its original source audio and the audio mashup (that is generated after combining two or more of the retrieved audios).

If a given section (e.g., of the retrieved audio) is a first section of its source audio file (meaning it would have a sequence value of 1 in its respective reference metadata), it may be considered the introduction of the song or the retrieved audio for the purposes of this adjustment. If the introduction section is placed as the first section within a channel, then all of the preceding audio for that section may be included in the audio mashup. For example, if the section 310A has a sequence value of 1, any audio prior to the start of the first beat of the section would be included during playback. The playhead 311 and playback time value 306 may go into negative timeline values to account for this adjustment while still aligning the beat grids of the various channels, or the system designer may choose to present this information differently in the audio editor user interface 300 to avoid using negatives.

The outro adjustment is effectively the inverse of the intro adjustment described above. If a given section is the final section from its source audio file (meaning it would have the maximum sequence value out of all sections from that source audio), it may be considered the outro of the song of the retrieved audio for the purposes of this adjustment. If such a section is the final section in its channel, thus having no section after it, the entirety of the audio after the end of the last beat from that section may be included in playback. For example, if the section 310B has a sequence value equal to the maximum of the sequence values of all sections from its source song, the section would play out from the start of its first beat through the end of the stem audio.

After the generation of the global project settings and application, adjustments, or modifications (of the key, the tempo, the time signature, the master volume, the crossfades, the sequence, the location, intros, and outros) of the respective stem audios, the respective audio files, and/or respective audio FX sections based on the global project settings, the additional effect application tool 172 can be used such that pre-effects (audio effects that are applied before combining adjusted or modified audios (e.g., stem audios, audio files, and/or audio FX sections that have been affected by or modified based on the global project settings)) can be applied to one or more of the adjusted or modified audios before combining the one or more of the adjusted or modified audios into a single audio file. More details are described below.

For example, pre-effects can be automatically applied (by the additional effect application tool 172) to one or more of the channels that include the adjusted or modified audios. For example, each of the channels that are to be combined into the single file for generating audio mashup may include the adjusted or modified audios, respectively, and pre-effects can be automatically applied individually to each (or one or more) of the channels.

The exact parameters of the pre-effects on each channel may vary depending on a preference of the system or software designer, and may be automatically applied on the adjusted or modified audios or sections thereof within the channels.

Pre-effects can include at least one of compression, equalizer or equalization (EQ) filtering, low frequency oscillator (LFO) ducking, sidechain ducking, etc. One or more of these pre-effects are described below in detail.

The compression (or effects of a compressor) may vary depending on mixing and mastering level of the audio files (that are used as one or more of the input audios), and/or whether such audio files have been already mixed and mastered before they were split or extracted into the stem audios (e.g., the stem audios 142 of the corresponding audio files 141). For example, the compression applied to the adjusted or modified audios may be a light compression (e.g., high threshold, slow attack, long decay, low ratio), if the audio files have already been mixed and mastered before they were split or extracted into the stem audios.

The EQ filtering may vary by channel, as different stem types may feature certain frequency ranges more heavily. For example, the instrumental channel 313B depicted in FIG. 3 may have no EQ filter on it, while the vocal channel 313A depicted in FIG. 3 may have a high pass EQ filter with a cutoff frequency of 120 Hz and slope of 48 dB per octave. Such configuration of EQ filter may prevent any low frequency information coming through the vocal channel 313A to interfere with a bass coming from the instrumental channel 313B. As such, different channels may have their own bespoke configuration for the EQ setting. In some implementations, such bespoke configuration for the EQ setting may be based on preference of the system or software designer.

Ducking is a process of changing the volume of the channel output (e.g., adjusted or modified audio within the channel), typically based on either the LFO or a sidechain input. This is most often used to “make room” for a kick drum, and its intensity is generally consistent within different genres of music. As such, the intensity of the effect may be adjusted based on the genre metadata (e.g., the first metadata) of the sidechain input.

The LFO ducking may leverage an LFO to adjust the volume of the channel output rhythmically based on LFO automation.

The sidechain ducking may leverage a sidechain input to determine a change in volume. The sidechain input may generally be the output of a different channel in the editor, or even a specific frequency band of a channel. The sidechain ducking may be performed by a compressor receiving the sidechain input, which is a concept common in modern music production. For example, the vocal channel 313A might have sidechain ducking applied based on the low frequency information of the instrumental channel 313B. The threshold for this example sidechain ducking may be set such that only kick drums trigger the vocal channel to be reduced in volume, and if the genre is “house” the intensity may be 100% and all other genres may be 25% intensity. Further variations may be introduced by the system or software designer, with more nuanced ducking parameter adjustments for different channel types.

Moreover, in addition to applying the pre-effects, the user can interact with the audio editor interface to incorporate or apply blanks section(s) and/or topline(s).

For example, the blank sections can be a subset of sections, like the audio FX sections, but are different in that blank sections are completely silent sections that may be placed in any channel, regardless of stem type. These blank sections behave just like typical sections otherwise, and their inclusion in a channel allows for a gap between two sections. Examples of how this could be useful include creating musical interludes during a mashup, or including acapella sections in the audio mashup. In an exemplary audio editor user interface 300 of FIG. 3, the user may access the blank sections by clicking on a blank section add button 317, where they can then be added to any channel in the editor.

For example, the toplines refer to the ability for sections that share the same stem type to be “stacked” on top of each other, such that they play simultaneously. When adding the topline to a given channel, the beat grid snapping for the topline section is akin to that of the audio FX, in that the topline sections are snapped within predefined increments in the beat grid. This may be in opposition to the “base” sections—the typical sections that underlie the topline sections—which are automatically strung together end to end. This gives topline sections the freedom to begin playing at any of the predefined points in the timeline, given that there are already base sections in the channel for the topline to be added to. Topline sections will have high pass EQ filtering applied automatically, such that bass frequencies from the topline do not interfere with that of its base section(s). The exact filter cutoff may vary pending the system's designer's taste, though generally settings of 120 Hz with a slope of 48 dB per octave work well for this purpose. Additional default effects may be applied to specific channel's toplines at the designer's discretion, including things like mid-side filtering, exciters, etc.

After the pre-effects and other manipulations (e.g., incorporation of audio FX section, blank section, toplines, etc.) are applied to the adjusted or modified audios, or to the channels that include the adjusted or modified audios, the mixing tool 170 may be used to combine the adjusted or modified audios into a single audio file or combine the channels into a single output channel that contains the single audio file.

For example, after the global settings are applied such that two or more stem audios or sections thereof are adjusted in their respective channels, these stem audios or sections, or respective channels thereof can be combined to a single output channel that is associated with the single audio file. In some implementations, adjusted audio FX sections may be combined along with the adjusted audio sections or adjusted stem audios into the single audio file.

Once the adjusted or modified audios are combined into the single audio file or channels that contain the adjusted or modified audios are combined into the single output channel that contains the single audio file, after-effects may be applied by the additional effect application tool 172 to the single audio file or the single output channel. The after-effects may correspond to final mastering audio effects that can be applied before outputting the single audio file that is ready for playback.

For example, after-effects may be light conventional mastering work. For example, such after-effects may include frequency collision detection and reduction, compression, and limiting.

With regards to the frequency collision detection and reduction, the frequency collision may be a generally undesirable result of different sounds competing for energy from the same frequency range. The additional effect application tool 172 may detail where such frequency collision is occurring, and trigger the EQ to reduce those frequencies output volumes. This EQ adjustment is often performed before the compressor or a limiter.

With regards to the compression, this concept is similar to the compression application to individual channels or the adjusted or the modified audios as described above. This compression may be applied before the limiting is applied.

With regards to the limiting (or effects of the limiter), this is typically applied at the end of the chain, and the parameters of the limiter may vary depending on the specific situation of the editor. For example, during local playback from the editor on the client device 120, the limiter may have an output ceiling of −0.3 dB. When being exported, the output ceiling may be reduced to better suit different use cases (for example, if sharing to another platform is facilitated directly via API, the limiter may optimize the settings for that particular platform).

After the after-effects are applied to the single audio file, the single audio file is output. For example, the single audio file may correspond to the audio mashup. For example, the single audio file may be output in a waveform onto the user interface such as the audio editor user interface 300. For example, the single audio file may be output onto a display screen of the device, such as the client device 120. For example, the single audio file may be played on the device.

In some implementations, outputting the single audio file may include a direct download to the device (with or without the user requesting for download), sharing via application programming interface (API) to other platforms or services, etc.

In some implementations, the adjusted or modified audios may be combined without application of the pre-effects.

In some implementations, the single audio file may be output without application of the after-effects.

In some implementations, the single audio file may be the audio remix.

In some implementations, a variety of user interfaces with more or less editing controls may be available to the user.

In some implementations, the audio mashup automation software 160 could be run on an appropriate server using scripts submitted by developers, Artificial Intelligence (AI) systems, or any manner of input to automatically generate mash ups of audio files.

In some implementations, if respective stem audios, respective reference metadata, and/or respective audio FX sections associated with the input audios are downloaded or stored in the client device 120, the audio mashup automation software 160 may run entirely in the client device 120 without accessing the data store 140.

FIG. 2 depicts an illustrative processor-based, computing device 200. The computing device 200 can implement audio mashup automation technique, run an application or software (e.g., the audio mashup automation software 160) related to audio mashup automation technique. The computing device 200 is representative of the type of computing device that may be present in or used in conjunction with at least some aspects of the client device 120 of FIG. 1 and/or other devices at least partially implementing functionality or techniques described with respect to the system 100 of FIG. 1, or any other device that includes electronic circuitry. The computing device 200 is illustrative only and does not exclude the possibility of another processor- or controller-based system being used in or with any of the aforementioned aspects of the client device 120.

In one aspect, the computing device 200 may include one or more hardware and/or software components configured to execute software programs, such as software for obtaining, storing, processing, and analyzing signals, data, or both. For example, the computing device 200 may include one or more hardware components such as, for example, a processor 205, a random-access memory (RAM) 210, a read-only memory (ROM) 220, a storage 230, a database 240, one or more input/output (I/O) modules 250, and an interface 260. Alternatively, and/or additionally, the computing device 200 may include one or more software components such as, for example, a computer-readable medium including computer-executable instructions for performing techniques or implement functions of tools consistent for automating prior authorizations. It is contemplated that one or more of the hardware components listed above may be implemented using software. For example, the storage 230 may include a software partition associated with one or more other hardware components of the computing device 200. The computing device 200 may include additional, fewer, and/or different components than those listed above. It is understood that the components listed above are illustrative only and not intended to be limiting or exclude suitable alternatives or additional components.

The processor 205 may include one or more processors, each configured to execute instructions and process data to perform one or more functions associated with the computing device 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, the processor 205 may be communicatively coupled to the RAM 210, the ROM 220, the storage 230, the database 240, the I/O module 250, and the interface 260. The processor 205 may be configured to execute sequences of computer program instructions to perform various processes (e.g., techniques), such as those described herein for automating prior authorizations. The computer program instructions may be loaded into the RAM 210 for execution by the processor 205.

The RAM 210 and the ROM 220 may each include one or more devices for storing information associated with an operation of the computing device 200 and/or the processor 205. For example, the ROM 220 may include a memory device configured to access and store information associated with the computing device 200, including information for identifying, initializing, and monitoring the operation of one or more components and subsystems of the computing device 200. The RAM 210 may include a memory device for storing data associated with one or more operations of the processor 205. For example, the ROM 220 may load instructions into the RAM 210 for execution by the processor 205.

The storage 230 may include any type of storage device configured to store information that the processor 205 may use to perform processes consistent with the disclosed implementations. The database 240 may include one or more software and/or hardware components that cooperate to store, organize, sort, filter, and/or arrange data used by the computing device 200 and/or the processor 205. For example, the database 240 may include end-user profile information, historical activity and end-user specific information, predetermined menu/display options, and other end-user related data. Alternatively, the database 240 may store additional and/or different information. The database 240 can be used to store admin data, patient data, order-related data, authorization-related data and/or other data used or generated in accordance with implementations of this disclosure.

The I/O module 250 may include one or more components configured to communicate information with a user associated with the computing device 200. For example, the I/O module 250 may comprise one or more buttons, switches, or touchscreens to allow a user to input parameters associated with the computing device 200. The I/O module 250 may also include a display including a graphical user interface (GUI) and/or one or more light sources for outputting information to the user. The I/O module 250 may also include one or more communication channels for connecting the computing device 200 to one or more secondary or peripheral devices such as, for example, a desktop computer, a laptop, a tablet, a smart phone, a flash drive, or a printer, to allow a user to input data to or output data from the computing device 200.

The Interface 260 may include one or more components configured to transmit and receive data via a communication network, such as the Internet, a local area network, a workstation peer-to-peer network, a direct link network, a wireless network, or any other suitable communication channel. For example, the interface 260 may include one or more modulators, demodulators, multiplexers, demultiplexers, network communication devices, wireless devices, antennas, modems, and any other type of device configured to enable data communication via a communication network.

FIG. 3 is an example illustration of the audio editor user interface 300 that is utilized as part of, or in conjunction with the audio mashup automation software 160 for generation of the audio mashup or the audio remix. As described above with respect to discussion of FIG. 1, the two or more input audios can be entered or inputted to the audio editor user interface 300. In FIG. 3, a section 310A of song A (“Drives Me Wild”) and a section 310B of song B (“My Love”) are entered. More specifically, the section 310A is entered in a vocal channel 313A and the section 310B is entered in an instrumental channel 313B. The vocal channel 313A may be a channel that designated or is used for retrieving a vocal stem audio of the input audio (e.g., section 310A of song A in this case), and the instrumental channel 313B may be a channel that is designated or used for retrieving an instrumental stem audio of the input audio (e.g., section 310B of song B in this case). Moreover, an audio FX channel 314 is depicted in FIG. 3, to where audio FX sections may be added.

Further, the concept of a beat grid as the background of the channels 313 and 314 is illustrated. Moreover, dashed lines (e.g., dashed lines 320) which represent bars, a playhead 311, a playback time value 306, and a blank section add button 317 are depicted. Detailed aspects of these components are described above with respect to discussion of the audio mashup automation software 160 of FIG. 1.

FIG. 4 is an example illustration 400 of an audio file presented on a generic beat grid, with a “section” demarcated in a waveform. For example, the waveform is laid against a beat grid, as part of the audio editor user interface 300. As described above, a section 403 may be a portion or the segment of a stem 402, represented as a waveform laid against a beat grid (as indicated by bar marker 401). As described above with respect to discussion of FIG. 1, such example illustration 400 can be used to facilitate understanding of the term “section” in this disclosure, which may refer to a distinct portion or a segment of an audio file (of the audio files 141), a stem audio (of the stem audios 142), or an audio FX section.

FIG. 5 is an example illustration 500 that depicts a circular nature of musical keys if one neglects different octaves. For purposes of clarity, this is not to be confused with the more popular music concept of the “Circle of Fifths.” As shown in FIG. 5, major and minor keys occupy the same portion of the circle—these pairings are relative keys, meaning that they share the same notes. The distance between each key is described as a “semitone.” Such example illustration 500 can be used to facilitate understanding of how minimum semitone adjustment and the reference key (as global project setting) are determined, as described above with respect to discussion of FIG. 1.

FIG. 6 is an example illustration 600 of a spreadsheet that depicts computation or calculation of reference tempo and/or tempo adjustments to added sections in channels of an audio editor. As discussed above with respect to section “Generation and/or Application of the Global Project Settings: Tempo” in the discussion of FIG. 1, such example illustration 600 may help facilitate understanding of how reference tempo (as global project setting) can be determined.

FIG. 7 is a flowchart of an example of a technique 700 for automatically generating or producing an audio mashup. The technique 700 may be implemented by processor-based device (device or music production device), such as the client device 120, the computing device 200, the data store 140, and/or a server. The computing device 200 is representative of a type of computing device that may be used in conjunction with at least some aspects of the audio mashup automation software 160. Further, the technique 700 may implement, be implemented by, or in conjunction with the technique 700 and/or the implementations described in the system 100 of FIG. 1.

At 702, two or more audio files (e.g., input audios) are received. For example, a user of the device may enter, select, or input two or more of the input audios. For example, the user may browse through, search for, or access the list of audio files (e.g., the audio files 141) stored in the server (e.g., the data store 140) and select two or more input audios of user's choice. For example, the user may select a song 1 and a song 2. For example, the user may select a section of the song 1 and a section of the song 2. For example, the user may select the song 1, a song 4, and song 5. Any combination of two or more input audios may be entered or inputted.

For example, the two or more input audios can be entered or inputted to an audio editor user interface (e.g., such as the audio editor user interface 300). For example, there may be channels configured to retrieve different types of stem audios, such as single instrument, multiple instruments, single vocal, multiple vocals, audio FX sections, etc. For example, individual channels can correspond to have a stem audio type (e.g., stem type) of acoustic guitar, piano, bass, orchestra (consisting of multiple instruments), drum, a single vocal, multiple vocals, drum, sub-components drum (e.g., kick drum, snare drum, toms, etc.), etc.

For example, assuming that the user prefers to use the guitar stem audio from the song C, then the user may input or place the input audio into a channel corresponding to guitar stem audio channel. For example, assuming that the user prefers to use the piano stem audio from the song D, then the user may input or place the input audio into a channel corresponding to piano stem audio channel. As such, by entering or inputting audio input on appropriate channel location (or to certain designated channel), designated type (e.g., of user's preference) of stem audio associated with the input audio may be automatically retrieved from the server.

In some implementations, the user may input one or more input audios that are located in a different server or stored in the device.

In some implementations, the user may download one or more audio files (from the server) on the device and user may enter or input the input audios from the one or more of downloaded audio files. Moreover, in some implementations, one or more audio files may be obtained or downloaded from a different medium or different route other than downloading from the server, and such audio files may be entered or inputted as input audios.

At 704, first metadata from the two or more audio files are extracted if the first metadata are included in or provided with the two or more audio files. The first metadata may be common metadata (e.g., metadata that is commercial in nature) that can be potentially or sometimes provided with, included in, or embedded in the two or more audio files. For example, the first metadata may include information associated with title, artist name, album (which certain audio file(s)) belong to), track number, year, genre, composer, lyricist, or general information associated with the audio files. For example, the first metadata may include information associated with tempo, time signature, key, downbeat locations, section start timestamps, section categories, energy levels near section starts and ends (e.g., both in total as well as within specific frequency bands). For example, one or more of the first metadata may be extracted.

This step 704 is optional. For example, when the first metadata are not included in or provided with the two or more audio files, step 704 can be skipped. For example, such first metadata may be retrieved as part of reference metadata from the server at step 706, as described below.

At 706, two or more stem audios and the reference metadata (which includes the first metadata and second metadata) are retrieved from the server.

In some implementations, the two or more stem audios and the first metadata and/or the second metadata may be automatically retrieved based on a unique identifier. For example, the unique identifier may be generated based on a concatenation of one or more of the extracted first metadata or basic information that can identify the two or more audio files, and stem information. For example, the stem information may correspond to which type of stem audio (e.g., guitar stem, instrumental stem, vocal stem, etc.) associated with the respective audio input should be retrieved from the data store 140. For example, the respective stem information may be automatically derived from location of the audio input, such as designation or location of channel (e.g., the vocal channel 313A, the instrumental channel 313B as shown in FIG. 3), as described above. Since location of the audio input may be linked with type of the stem audio to be retrieved, when the audio input is in that very location (e.g., designated channel for certain stem type), the respective stem information may be derived or identified, and further included in the concatenation.

For example, the unique identifier may correspond to the concatenation of a respective first metadata or basic information (e.g., respective title, a respective artist name, or information that may help identify an audio file) associated with a respective audio file. For example, the unique identifier may correspond to the concatenation of a respective title, the respective artist's name, and the respective stem information.

For example, the respective concatenation may be used as the unique identifier or the lookup to find a matching unique identifier in the server to retrieve or access the respective second metadata and the respective stem audios.

As the unique identifier may be used to retrieve the reference metadata (which includes the first metadata and/or the second metadata), the unique identifier may be used to retrieve not only the respective second metadata and the respective stem audios, but also the respective first metadata. Moreover, in some implementations, if optional step 704 is performed and if one or more of first metadata, such as first metadata that are specific to and associated with the stem audios (that are to be retrieved or retrieved) are needed and/or missing from the extracted first metadata, then such first metadata may be retrieved from the server. Moreover, in some implementations, the unique identifier may also be used to retrieve audio FX sections and/or audio FX plug-ins.

At 708, two or more stem audios or segments (e.g., portions, sections) thereof are automatically adjusted. The two or more stem audios or the segments of the two or more stem audios may be (e.g., automatically) adjusted based on reference settings (e.g., the global project settings). As described above, the global project settings may be master project settings or commands that can be generated based on the respective reference metadata (e.g., first metadata and/or second metadata associated with respective stem audios, respective audio files, or respective audio FX sections) and be utilized on or applied to the respective stem audios, the respective audio files, or the respective audio FX sections.

For example, the global project settings may be utilized on or applied to the respective stem audios, the respective audio files, or the respective audio FX sections. For example, applying the global project settings to the respective stem audios, the respective audio files, or the respective audio FX sections may include utilizing, applying, or modifying key, tempo, time signature, master volume, and/or crossfades to the respective stem audios, the respective audio files, or the respective audio FX sections based on global parameters (e.g., master parameters, reference parameters, commands) represented by the global project settings.

Moreover, for example, applying the global project settings to the respective stem audios, the respective audio files, or the respective audio FX sections may include adjusting or modifying a sequence or a location where the respective stem audios, the respective audio files, or the respective audio FX sections will be put.

For example, the global project settings can be automatically generated based on the respective reference metadata or the respective stem audios, and automatically applied not only to the respective stem audios, but also to the respective audio files, or the respective audio FX sections if the respective audio files, or the respective audio FX sections are also used (e.g., combined with the segments of the stem audios or the stem audios) toward generating the audio mashup.

With regards to the generation of the global project settings, determining a reference key (as a global project setting or global parameter that represents the global project setting) may include determining, based on respective first metadata and/or the respective second metadata, a minimum number of semitones that need to be adjusted in at least one of the two or more retrieved stem audios. Such reference key may be applied or used to modify the key of the respective stem audios, the respective audio files, or the respective audio FX sections. Implementations described above with respect to discussion “Generation and/or Application of the Global Project Settings: Key” of FIG. 1 can be incorporated herein.

With regards to the generation of the global project settings, determining a reference tempo (as a global project setting or global parameter that represents the global project setting) may include determining, based on the reference metadata (first metadata and/or the second metadata), an average tempo of retrieved stem audios that are going to be combined to create the audio mashup or audio remix, and computing or identifying the reference tempo based on the average tempo. For example, computing or identifying the reference tempo based on the average tempo may include determining a first difference between a respective tempo of at least one of the retrieved stem audio and the average tempo, determining a second difference between the respective tempo and twice value of the average tempo, determining a third difference between the respective tempo and half value of the average tempo, and determining a smallest value among the first difference, the second difference, and the third difference. Then the reference tempo may be a tempo corresponding to one of the average tempo, the twice value of the average tempo, and the half value of the average tempo that led to the smallest value.

Moreover, in some implementations, in supplant of the average tempo, certain project tempo can be manually set by the user, or pre-configured or configured (e.g., in the audio mashup automation software 160), as described above with respect to discussion “Generation and/or Application of the Global Project Settings: Tempo” of FIG. 1.

With regards to the generation of the global project settings, determining the reference time signature (as a global project setting or global parameter that represents the global project setting) may include determining, based on the reference metadata (first metadata and/or the second metadata), alignment locations for the two or more retrieved stem audios. Such reference time signature may allow for synchronous playback when two or more retrieved stem audios are combined. Implementations described above with respect to discussion “Generation and/or Application of the Global Project Settings: Time Signature” of FIG. 1 can be incorporated herein.

Moreover, with regards to the generation and/or application of the master volume, the crossfades, implementations described above with respect to discussion “Generation and/or Application of the Global Project Settings: Master Volume and Crossfades” of FIG. 1 can be incorporated herein.

As such, the global project settings can be automatically generated based on the respective reference metadata or the respective stem audios, and automatically applied to the respective stem audios, the respective audio files, or the respective audio FX sections, such that the two or more stem audios or segments thereof are automatically adjusted.

In some implementations, the global project settings can be manually set or adjusted by the user before or after the audio input is inputted or entered.

In some implementations, the global project settings may be output as a recommendation to the user and the user can manually set or adjust the settings prior to the application of the global project settings.

In some implementations, prior to generation and application of global settings, the user may manually modify locations of the sections of the respective stem audios and/or respective audio FX sections within respective channels.

At 710, adjusted audio segments or adjusted stem audios are combined into a single audio file. For example, after the global settings are applied such that two or more stem audios or segments thereof are adjusted in their respective channels, these stem audios or segments, or respective channels thereof can be combined to a single output channel that is associated with the single audio file.

In some implementations, adjusted audio FX sections may be combined along with the adjusted audio segments or adjusted stem audios into the single audio file.

In some implementations, prior to combining the adjusted stem audios or the adjusted stem audio segments, pre-effects can be applied to each individual channel that includes the adjusted stem audios or the adjusted stem audio segments. For example, the pre-effects can be applied in a similar manner as described above with respect to discussion of FIG. 1.

In some implementations, after combining the adjusted stem audios or the adjusted stem audio segments, after-effects can be applied to the single audio file. For example, the after-effects can be applied in a similar manner as described above with respect to discussion of FIG. 1.

At 712, the single audio file is output. For example, the single audio file may correspond to the audio mashup. For example, the single audio file may be output in a waveform onto the user interface such as the audio editor user interface 300. For example, the single audio file may be output onto a display screen of the device, such as the client device 120. For example, the single audio file may be played on the device.

In some implementations, outputting the single audio file may include a direct download to the device (with or without the user requesting for download), sharing via application programming interface (API) to other platforms or services, etc.

In some implementations, the single audio file may be the audio remix.

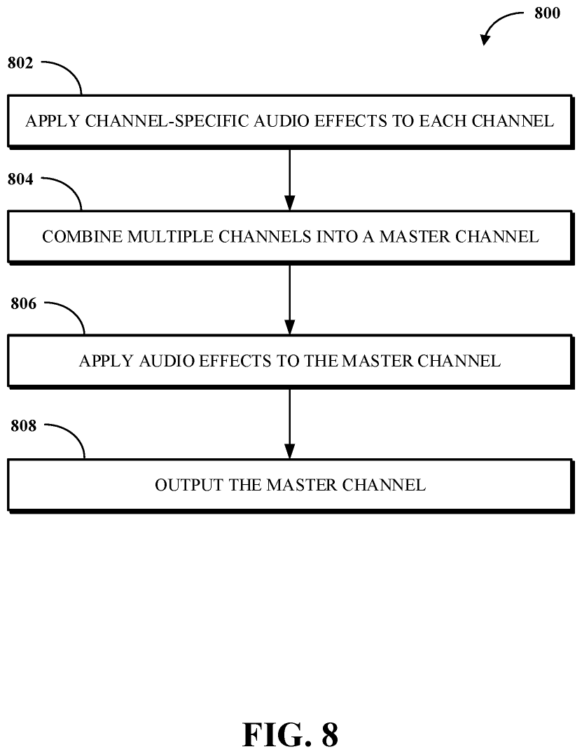

FIG. 8 is a flowchart of an example of a technique 800 for applying channel-specific audio effects to retrieved audios prior to combining channels and applying audio effects to combined channels to generate or produce an audio mashup. The technique 800 may be implemented by processor-based device, such as the client device 120, the computing device 200, the data store 140, and/or a server. The computing device 200 is representative of a type of computing device that may be used in conjunction with at least some aspects of the audio mashup automation software 160. Further, the technique 800 may implement, be implemented by, or in conjunction with the technique 700 and/or the implementations described in the system 100 of FIG. 1.

At 802, channel-specific audio effects (e.g., the pre-effects) are applied to each channel (that will be used to produce the audio mashup) after two or more audio segments of the stem audios or the stem audios are adjusted based on global project settings, respectively. For example, after step 708 of the technique 700 of FIG. 7, the pre-effects may be applied to each channel.

For example, the pre-effects can be automatically applied to one or more of the adjusted audios or the one or more of the channels that include the adjusted audios. For example, each of the channels that are to be combined into the single file for generating the audio mashup may include the adjusted audios, respectively, and pre-effects can be automatically applied individually to each (or one or more) of the channels. For example, the pre-effects can include at least one of compression, equalizer or equalization (EQ) filtering, low frequency oscillator (LFO) ducking, sidechain ducking, etc.

The pre-effects can be applied in a similar manner as described above with respect to discussion of FIG. 1.

At 804, after the pre-effects are applied, channels may be combined into a single output channel. For example, after the global settings are applied such that two or more stem audios or sections thereof are adjusted in their respective channels, these stem audios or sections, or respective channels thereof can be combined into the single output channel that is associated with the single audio file. In some implementations, adjusted audio FX sections may be combined along with the adjusted audio sections or adjusted stem audios into the single audio file.

At 806, audio effects (e.g., the after-effects) are applied to the master channel. For example, after the adjusted audios are combined into the single audio file or channels that contain the adjusted audios are combined into the single output channel that contains the single audio file, after-effects may be applied to the single audio file or the single output channel. The after-effects may correspond to final mastering audio effects that can be applied before outputting the single audio file that is ready for playback. For example, after-effects may be light conventional mastering work. For example, such after-effects may include frequency collision detection and reduction, compression, and limiting.

The after-effects can be applied in a similar manner as described above with respect to discussion of FIG. 1.

At 808, the master channel is output. Since the step used here can be the same as described with regards to step 712 of the technique 700 of FIG. 7, description of the step is not repeated here.

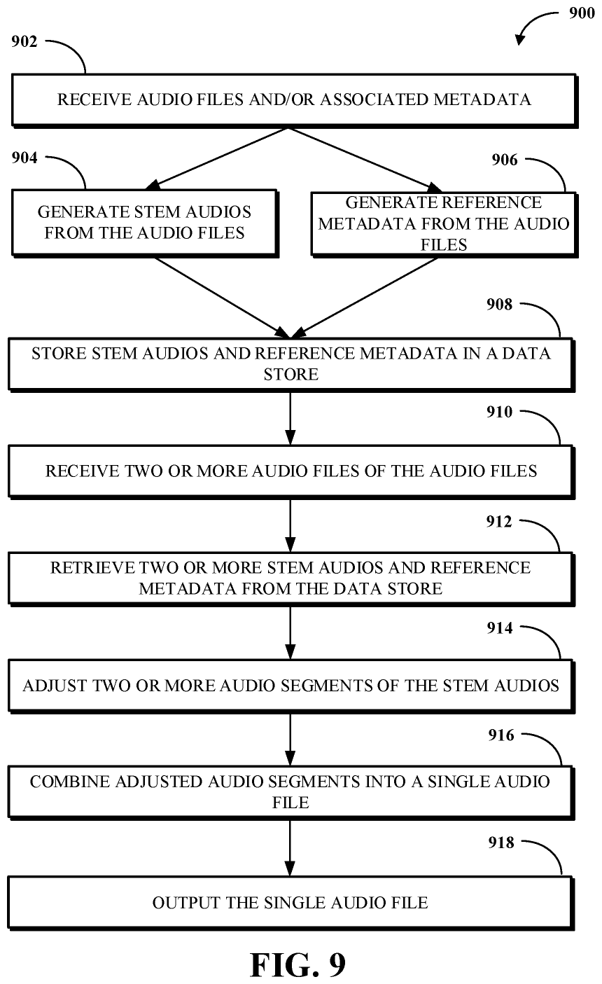

FIG. 9 is a flowchart of an example of a technique 900 for extracting or creating stem audios and metadata, and using such extracted stem audios and metadata to generate or produce an audio mashup. The technique 900 may be implemented by processor-based device, such as the client device 120, the computing device 200, the data store 140, and/or a server. The computing device 200 is representative of a type of computing device that may be used in conjunction with at least some aspects of the audio mashup automation software 160. Further, the technique 800 may implement, be implemented by, or in conjunction with the technique 700, the technique 800 and/or the implementations described in the system 100 of FIG. 1.

At 902, audio files and/or associated metadata (e.g., metadata tag, one or more of the first metadata 145) are received. For example, the audio files and/or associated metadata may be received from the one or more audio providers (e.g., music record label, music distributor, local device storage, digital audio workstation software, or any other sources that have at least some of the audio files). For example, such audio files and/or associated metadata may be received by the server manually or automatically from the audio providers. For example, the server such as the data store 140 may be associated with a software that can be used by the audio providers to automatically input or provide the audio files and/or the associated metadata.

At 904, stem audios are extracted or generated from the audio files. For example, a software running on the server or the device may be configured with instructions to automatically extract the stem audios from the audio files that are received from step 902. In some implementations, the audio provider or a third-party service provider can extract the stem audios from the audio files or split the audio files into the stem audios, and provide the stem audios to the server. In some implementations, third-party software may be used to automatically extract or generate the stem audios from the audio files when the audio files and/or the associated metadata are received at step 902. In some implementations, the ML model may be trained and used on the device or the server such that the stem audios are automatically extracted or generated from the audio files, as described above with respect to discussion of FIG. 1.

At 906, reference metadata (e.g., the reference metadata 144) that includes first metadata (e.g., the first metadata 145) and/or second metadata (e.g., the second metadata 146) may be generated from the audio files and/or the associated metadata received at step 902. For example, extraction or retrieval technologies such as self-similarity matrix, neural networks, etc. or other feasible music extraction or retrieval technologies that can be used to automatically extract a certain categories of information (such as one or more metadata of the reference metadata) based on the first metadata, one or more of the audio files, and/or one or more of the stem audios may be used to generate the reference metadata (e.g., the first metadata and/or the second metadata). Moreover, such extraction or retrieval technologies may be used not only to extract or retrieve the certain categories of information such as the reference metadata, but also to relate or associate the extracted reference metadata to respective stem audios (e.g., the stem audios 142). In some implementations, ML model may be trained and used to output reference metadata based on audio files (received at step 902) and/or the stem audios (generated at step 904), and/or associate such reference metadata to the audio files or the stem audios. In some implementations, such reference metadata may be entered manually. Such training of the ML model and using the ML model to generate and/or output the reference metadata and the stem audios, and associating the reference metadata to the audio files or the stem audios can be conducted in a similar manner as described above with respect to discussion of FIG. 1.

Such process of extraction, generation, or derivation (collectively “production”) of the reference metadata may run in parallel or asynchronously with generation of the stem audios from the audio files. For example, the reference metadata may be produced while received audio files are being extracted or split into the stem audios as described above. For example, the reference metadata the stem audios and/or the audio files may be produced after the received audio files are extracted or split into the stem audios.

At 908, the stem audios and the reference metadata may be stored in the server, such as the data store 140. For example, the stem audios and the reference metadata may be stored under the same profile associated with the stem audios or the audio files. For example, the stem audios and the reference metadata may be stored or linked under the same unique identifier (e.g., the unique identifier described above) associated with the stem audios or the audio files. For example, the unique identifier may correspond to a concatenation of first metadata (of the reference data) or basic information (e.g., respective title, a respective artist name, or information that may help identify an audio file) associated with a respective audio file. For example, same profile, the unique identifier, or link that associates the stem audios, the reference metadata, and/or the audio files may be generated or created as a result of using the ML model described above with respect to step 906.

At 910, two or more audio files (e.g., input audios) are received from the device. For example, a user of the device may enter, select, or input two or more of the input audios.

Since the step used here can be the same as described with regards to step 702 of the technique 700 of FIG. 7, description of the step is not repeated here.

At 912, two or more stem audios and reference metadata are retrieved from the server. For example, based on data identifying or data store lookup method, two or more stem audios and the reference metadata that are associated with the two or more stem audios (or input audios) may be identified. For example, as described in step 704 of the technique 700 of FIG. 7, the unique identifier may be first generated based on a concatenation of first metadata (if the first metadata included along with or within the input audios) or basic information extracted or derived from the input audios, and such unique identifier may be used to lookup matching unique identifier in the server. Moreover, other data retrieval method can be used. Moreover, the step used here can be the similar to those described with regards to step 706 of the technique 700 of FIG. 7.

At 914, two or more audio segments of the stem audios may be adjusted. For example, the two or more stem audios or the segments of the two or more stem audios may be adjusted based on reference settings (e.g., the global project settings). Since the step used here can be the same as described with regards to step 708 of the technique 700 of FIG. 7, description of the step is not repeated here.

At 916, adjusted audio segments or adjusted stem audios are combined into a single audio file. Since the step used here can be the same as described with regards to step 710 of the technique 700 of FIG. 7, description of the step is not repeated here.

At 918, the single audio file is output. Since the step used here can be the same as described with regards to step 712 of the technique 700 of FIG. 7, description of the step is not repeated here.

It should be noted that the applications and implementations of this disclosure are not limited to the examples, and alternations, variations, or modifications of the implementations of this disclosure can be achieved for any computation environment.

It may be appreciated that various changes can be made therein without departing from the spirit and scope of the disclosure. Moreover, the various features of the implementations described herein are not mutually exclusive. Rather any feature of any implementation described herein may be incorporated into any other suitable implementation.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

The disclosure, using specific embodiments and computations or calculations as examples, is meant for illustrative purposes and is not meant to be an exhaustive or limiting description of the invention. Embodiments of the disclosure may require more or less human input, may offer variations on the specific parameter defaults, and may involve more or less devices interaction. The language used in this disclosure was chosen for instructional purposes, such that somebody skilled in audio engineering and audio technology development could read and reproduce the invention. Therefore, the embodiments described are intended to help describe, but not limit, the functionality of the disclosure.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
receiving, by a music production device, two or more audio files;
retrieving, based on the two or more audio files and by the music production device, two or more stem audio files and reference metadata associated with the two or more stem audio files from a data store, wherein each of the two or more stem audio files includes at least one of an instrument portion or a vocal portion that are included in the two or more audio files;
adjusting, based on the reference metadata and by the music production device, two or more audio segments of the two or more stem audio files;
combining, by the music production device, adjusted two or more audio segments into a single audio file; and
outputting, by the music production device, the single audio file.

2. The method of claim 1, wherein:
the reference metadata includes data associated with a respective key, a respective tempo, and a respective time signature of each of the two or more stem audio files, and
data associated with at least one of chronological orders, durations, downbeat locations, or end beat locations of the two or more audio segments or the two or more stem audio files.

3. The method of claim 1, wherein:
the two or more audio files include a first audio file and a second audio file;
the two or more audio segments comprise a vocal portion of the first audio file and an instrument portion of the second audio file; and
the single audio file corresponds to an audio mashup.

4. The method of claim 1, wherein retrieving the two or more stem audio files and the reference metadata from the data store includes:
using a respective identifier corresponding to a concatenation of a respective title, a respective artist name, and a respective stem information associated with a respective file of the two or more audio files to retrieve the two or more stem audio files and the reference metadata.

5. The method of claim 1, wherein adjusting the two or more audio segments include:
determining, based on the reference metadata, global project setting associated with a reference key; and
adjusting a respective key of the two or more audio segments by applying the global project setting.

6. The method of claim 1, wherein adjusting the two or more audio segments include:
determining, based on the reference metadata, global project setting associated with a reference tempo; and
adjusting a respective tempo of at least one of the two or more audio segments by applying the global project setting.

7. The method of claim 1, wherein adjusting the two or more audio segments include:
determining, based on the reference metadata, global project setting associated with reference time signatures; and
aligning the two or more audio segments by applying the global project setting for synchronous playback.

8. A system comprising:
a memory subsystem storing instructions; and
processing circuitry configured to execute the instructions to:
receive, by a music production device, two or more audio files;
retrieve, based on the two or more audio files and by the music production device, two or more stem audio files and reference metadata associated with the two or more stem audio files from a data store, wherein each of the two or more stem audio files includes at least one of an instrument portion or a vocal portion that are included in the two or more audio files;
adjust, based on the reference metadata and by the music production device, two or more audio segments of the two or more stem audio files;
combine, by the music production device, adjusted two or more audio segments into a single audio file; and
output, by the music production device, the single audio file.

9. The system of claim 8, wherein:
the reference metadata includes data associated with a respective key, a respective tempo, and a respective time signature of each of the two or more stem audio files, and data associated with at least one of a chronological orders, durations of the two or more audio segments, downbeat locations, or end beat locations of the two or more stem audio segments or the two or more stem audio files.

10. The system of claim 8, wherein:
the two or more audio files include a first audio file and a second audio file;
the two or more audio segments comprise a vocal portion of the first audio file and an instrument portion of the second audio file; and
the single audio file corresponds to an audio mashup.

11. The system of claim 8, wherein to retrieve the two or more stem audio files and the reference metadata from the data store includes to:
use a respective identifier corresponding to a concatenation of a respective title, a respective artist name, and a respective stem information associated with a respective file of the two or more audio files to retrieve the two or more stem audio files and the reference metadata.

12. The system of claim 8, wherein to adjust the two or more audio segments includes to:
determine, based on the reference metadata, global project setting associated with a reference key; and
adjust a respective key of the two or more audio segments by applying the global project setting.

13. The system of claim 8, wherein to adjust the two or more audio segments includes to:
determine, based on the reference metadata, global project setting associated with a reference tempo; and
adjust the respective tempo of at least one of the two or more audio segments by applying the global project setting.

14. The system of claim 8, wherein to adjust the two or more audio segments includes to:
determine, based on the reference metadata, global project setting associated with reference time signatures; and
align the two or more audio segments by applying the global project setting for synchronous playback.

15. A non-transitory computer readable medium storing instructions operable to cause one or more processors to perform operations for automating audio mashup production, the operations comprising:
receiving, by a server, two or more audio files;
generating, by the server, two or more stem audio files based on the two or more audio files;
generating, by the server, reference metadata based on the two or more stem audio files, or the two or more audio files;
receiving, by a music production device, the two or more audio files;
retrieving, based on the two or more audio files and by the music production device, the two or more stem audio files and the reference metadata from the server;
adjusting, based on the reference metadata and by the music production device, two or more audio segments of the two or more stem audio files; and
combining, by the music production device, adjusted two or more audio segments into a single audio file.

16. The non-transitory computer readable medium of claim 15, wherein:
the reference metadata includes data associated with a respective key, a respective tempo, and a respective time signature of each of the two or more audio files or each of the two or more stem audio files, and data associated with at least one of chronological orders, durations, downbeat locations, or end beat locations of the two or more stem audio segments or the two or more stem audio files.

17. The non-transitory computer readable medium of claim 15, wherein:
the two or more audio files include a first audio file and a second audio file;
the two or more audio segments comprise a vocal portion of the first audio file and an instrument portion of the second audio file; and
the single audio file corresponds to an audio mashup.

18. The non-transitory computer readable medium of claim 15, wherein retrieving the two or more stem audio files and the reference metadata from the server includes:
using a respective identifier corresponding to a concatenation of a respective title, a respective artist name, and a respective stem information associated with a respective file of the two or more audio files to retrieve the two or more stem audio files and the reference metadata.

19. The non-transitory computer readable medium of claim 15, wherein adjusting the two or more audio segments include:
determining, based on the reference metadata, global project setting associated with a reference key; and
adjusting a respective key of the two or more audio segments by applying the global project setting.

20. The non-transitory computer readable medium of claim 15, wherein adjusting the two or more audio segments include:
determining, based on the reference metadata, global project setting associated with a reference tempo; and
adjusting a respective tempo of the two or more audio segments by applying the global project setting.
